(19) United States
(12) Patent Application Publication
(10) Pub. No.: US 2009/0327714 A1
(43) Pub. Date: Dec. 31, 2009

(54) System and Method for End-to-End Electronic Mail-Encryption

(76) Inventor: Karim Yaghmour, Sherbrooke (CA)

Correspondence Address: JACOBSON HOLMAN PLLC, 400 SEVENTH STREET N.W., SUITE 600, WASHINGTON, DC, 20004, US

(21) Appl. No.: 12/086,697

(22) PCT Filed: Dec. 19, 2006
(86) PCT No.: PCT/CA2006/002083

§ 371 Date: May 18, 2009

(30) Foreign Application Priority Data
Dec. 19, 2005 (CA) 2531163
Dec. 20, 2005 (CA) 2530937

(51) Int. Cl. H04L 9/28; H04L 9/14; H04L 12/54

(52) U.S. Cl. 713/168; 380/28

(57) ABSTRACT

The present disclosure provides a system and method for end-to-end electronic mail encryption. In one embodiment, the sender contacts a payload-encryption-packet creation server which receives the message the sender would like to encrypt, generates an encrypted message and a payload-encryption-packet, and returns both to the sender. The sender then uses his regular email infrastructure to transmit to the recipient the encrypted message and the payload-encryption-packet as a single email. Upon receiving the sender's email, the recipient contacts a payload-encryption-packet processing server and sends it the payload-encryption-packet and authorization information. Depending on the validity of the authorization information, said server processes the payload-encryption-packet and provides the recipient with information usable for extracting the original message from the encrypted message.

This application is related to Canada Application No. 2,531,163, titled “System and Method for Providing Certified Proof of Delivery Receipts for Electronic Mail,” filed on Dec. 19, 2005, the entire contents of which are incorporated herein by reference; and Canada Application No. 2,530,937, titled “System and Method for End-to-End Electronic Mail Encryption,” filed on Dec. 20, 2005, the entire contents of which are incorporated herein by reference.

### FIELD OF INVENTION

The present disclosure relates to data processing and, more particularly, to a method and system for end-to-end encryption of electronic mail messages using mechanisms based on public key encryption and symmetric key encryption.

### BACKGROUND

Electronic mail (e-mail) has become a primary means of communication for a large number of organizations, businesses and individuals. Email, however, is an inherently insecure means of communication given that all messages sent between senders and recipients are practically transmitted in clear text over networks. In sum, sending email is like sending a postcard. This fact, nevertheless, does not deter a large portion of email users to continue using email as a conduit for sensitive, confidential data, and yet other users to avoid email altogether for any sort of sensitive transfers. While some email users, and/or the organizations they belong to, have started using encryption as a means to secure email data transfers, the vast majority of email users continue to transfer sensitive information using regular, unencrypted email. The fact of the matter is that none of the existing solutions for providing email encryption, and there are a great deal many of these, have been able to strike the right balance between security, ease-of-use and ease-of-deployment.

Instead of covering each previously existing solution one-by-one in the present section, the Detailed Description of the Preferred Embodiments section below will provide a detailed analysis of how the present disclosure compares to said solutions. In sum, while many attempts have been made to solve the issues of security, ease-of-use and ease-of-deployment, there has yet to be a single solution that has succeeded in being widely adopted.

There is thus a need for a powerful, yet simple email encryption system and method. There is also thus a need for an email encryption system and method which is simple to deploy and manage. In other words, there is a need for an email encryption system and method wherein the existing email infrastructure remains unchanged, in as much as possible, and would therefore not be impacted, or be impacted as little as possible, by the use of such a system and method by the existing users.

There is also thus a need for an email encryption system and method which is simple to to use. In other words, there is a need for an email encryption system and method wherein the sender can send an encrypted email to any recipient, whether or not said recipient has previously obtained a cryptographic identity or published a public key. Ideally, such a system and method should integrate intuitively into the sender's and the recipient's existing habits without requiring either to have grasped the underlying principles surrounding the use of public key cryptography and, yet, without compromising on security.

### SUMMARY OF THE INVENTION

An object of the present disclosure is to provide an email encryption system and method that overcome at least one of the drawbacks of the previously existing solutions and that satisfy at least one of the above-mentioned needs.

Another object of the present disclosure is to provide an email encryption system and method wherein the failure of the encryption system and method would not result in an email outage. In other words, existing email infrastructure should be left unaffected by the failure of the functionality enabling or providing encryption.

Another object of the present disclosure is to provide an email encryption system and method wherein senders need not entrust their email for storage by a Trusted-Third Party (TTP).

Another object of the present disclosure is to provide an email encryption system and method which would be difficult for malicious third parties to abuse from in order to conduct spam or phishing attacks.

Another object of the present disclosure is to provide an email encryption system and method wherein the initial deployment of the encryption functionality imposes no, or few, perturbations on the existing email infrastructure.

Another object of the present disclosure is to provide an email encryption system and method wherein the scalability of the components part of the system and method does not depend, or depends in as little as possible, on the number of emails processed by said system or method.

Another object of the present disclosure is to provide an email encryption system and method wherein the network traffic necessary for the recipient to decrypt his email is minimized.

Another object of the present disclosure is to provide an email encryption system and method wherein recipients designated by a sender in a sent email do not need to have previously published cryptographic identities, such as a public key, or otherwise be known to any TTP.

Another object of the present disclosure is to provide an email encryption system and method relying on public key cryptography wherein the key pairs used may be replaced from time to time. In other words, the system and method are built to mitigate the risks associated with the compromising of any given private key.

Another object of the present disclosure is to provide an email encryption system and method wherein organizations using the system and method do not need to create, publish or manage a key pair for every single user they would like to have using the system and method.

Another object of the present disclosure is to provide an email encryption system and method wherein recipients can respond back to senders in an encrypted fashion.

At least one of the preceding objects is met, in whole or in part, by the present disclosure, in which there is provided a system and method for email encryption.

According to the present disclosure, there is provided a system for email encryption, comprising:
an email transmission module configured for sending an email;
a payload-encryption-packet creation module operating remotely from the email transmission module, the payload-encryption-packet creation module being configured for producing a payload-encryption-packet in response to a request for creating a payload-encryption-packet, wherein the payload-encryption-packet is produced as a function of an encryption key;
a payload-encryption-packet creation trigger module connectable to the payload-encryption-packet creation module, the payload-encryption-packet creation trigger module being configured for, contemporaneously with the sending of the email:
   generating the request for creating the payload-encryption-packet,
   causing the generation of an encrypted email, wherein the encrypted email is produced as a function of the email and the encryption key, and
   causing the substitution of the email with the encrypted email;
a payload-encryption-packet processing module configured for returning the encryption key in response to a request for processing the payload-encryption-packet; and
a payload-encryption-packet processing trigger module connectable to the payload-encryption-packet processing module, the payload-encryption-packet processing trigger module being configured for triggering the request for processing the payload-encryption-packet contemporaneously with the reception of the payload-encryption-packet and receiving the encryption key, thereby enabling the decryption of the encrypted email.

According to the present disclosure, there is also provided a system for email encryption, comprising:
an email transmission module configured for sending an email;
a payload-encryption-packet creation module operating remotely from the email transmission module, the payload-encryption-packet creation module being configured for producing a payload-encryption-packet in response to a request for creating the payload-encryption-packet, wherein the payload-encryption-packet is produced as a function of data identifying the recipient;
a payload-encryption-packet creation trigger module connectable to the payload-encryption-packet creation module, the payload-encryption-packet creation trigger module being configured for generating the request for creating the payload-encryption-packet contemporaneously with the sending of the email and configured for causing the email to be substituted with an encrypted email, wherein the encrypted email is produced as a function of the email and cryptographic information found in the payload-encryption-packet;
a payload-encryption-packet processing module configured for returning cryptographic information necessary for decrypting the encrypted email in response to a request for processing the payload-encryption-packet;
an email reception module configured for receiving the email; and
a payload-encryption-packet processing trigger module connectable to the payload-encryption-packet processing module, the payload-encryption-packet processing trigger module being configured for triggering the request for processing the payload-encryption-packet contemporaneously with the reception of the payload-encryption-packet, whereby the cryptographic information returned by the payload-encryption-packet processing module is used to decrypt the encrypted email received by the email reception module.

The system may further comprise a payload-encryption-packet transmission module configured for causing the sending of the payload-encryption-packet and a payload-encryption-packet reception module configured for receiving the payload-encryption-packet. The system may also further comprise a random key generation module connectable to the payload-encryption-packet creation module, the random key generation module being configured for generating a symmetric key. The system may additionally further comprise a symmetric key encryption module connectable to the payload-encryption-packet creation module, the symmetric key encryption module being configured for producing an encrypted symmetric key as a function of a public key and the symmetric key, wherein the encrypted symmetric key is made to be a component of the payload-encryption-packet. The system may in addition comprise an email encryption module connectable to the payload-encryption-packet creation module, the email encryption module being configured for producing the encrypted email as a function of the symmetric key. The system may moreover further comprise a payload-encryption-packet formatting module configured for producing an email in payload-encryption format by combining the encrypted email with the payload-encryption-packet. The system may also further comprise a payload-encryption-packet transmission module configured for substituting the email with the email in payload-encryption format, wherein said substitution is effected contemporaneously with the transmission of the email by the email transmission module.

According to the present disclosure, there is also provided a method for email encryption, comprising the steps of:
a) generating a request for producing a payload-encryption-packet contemporaneously with the sending of an email, wherein the email is sent by an email transmission module;
b) producing a payload-encryption-packet remotely from the email transmission module in response to the request for producing a payload-encryption-packet;
c) producing an encrypted email as a function of the email and cryptographic information contained in the payload-encryption-packet;
d) substituting the email with the encrypted email;
e) generating a request for processing the payload-encryption-packet contemporaneously with the reception of the payload-encryption-packet; and
f) extracting the cryptographic information found in the payload-encryption-packet for use in decrypting the encrypted email received by the email reception module.

According to the present disclosure, there is also provided another method for email encryption, comprising the steps of:
a) generating a request for producing a payload-encryption-packet contemporaneously with the sending of an email, wherein the email is sent by an email transmission module;
b) generating a symmetric key remotely from the email transmission module in response to the request for producing a payload-encryption-packet, wherein the content of the payload-encryption-packet can only be accessed by authorized recipients;
c) encrypting the email using the symmetric key, thereby obtaining an encrypted email;
d) encrypting the symmetric key using a public key, thereby obtaining an encrypted symmetric key;
e) substituting the email with an email in payload-encryption format, wherein the email in payload-encryption format is produced as a function of the encrypted email and the encrypted symmetric key;
f) generating a request for processing the payload-encryption-packet contemporaneously with the reception of the email in payload-encryption format by an email reception module;
g) authenticating the recipient on whose behalf the request for processing the payload-encryption-packet is generated;
h) decrypting the encrypted symmetric key found in the email in payload-encryption format using a private key, thereby obtaining a decrypted symmetric key; and
i) decrypting the encrypted email found in the email in payload-encryption format using the decrypted symmetric key.

Preferably, but not necessarily, the sender contacts a payload-encryption-packet creation server which identifies the sender as being authorized to use its services, receives the message the sender would like to encrypt for the recipient or recipients, generates a random symmetric key, encrypts the sender's message with the symmetric key, encrypts, possibly once for each recipient, the symmetric key and other data items related to the message either using a public key associated with each recipient or each recipient's organization or, if for instance no public key is associated with a recipient, using a mechanism based on a sender-provided access token (possibly a simple passphrase) and possibly aggregates this with yet more data items related to the message, thereby creating a payload-encryption-packet, and returns the encrypted message and the payload-encryption-packet to the sender. The sender then uses his regular email infrastructure to transmit to the recipient or recipients the encrypted message and payload-encryption-packet. Upon receiving the sender's email, a recipient contacts a payload-encryption-packet processing server which has a copy of the recipient's private key and/or means for extracting the symmetric key used to encrypt the sender's message using, partly, the mechanism based on a sender-provided access token. The payload-encryption-packet processing server first identifies the recipient as being authorized to use its services—such identification could be very basic to the extent that no verification is carried out by the payload-encryption-packet processing server, or it could be very elaborate and require the use of passwords or the likes. Having been authorized to use the payload-encryption-packet processing server, the recipient sends it the payload-encryption-packet which contains the encrypted symmetric key originally used by the payload-encryption-packet creation server to encrypt the sender's message. The payload-encryption-packet processing server then extracts the symmetric key and provides it back to the recipient which can then decrypt and read the sender's message.

Preferably, but not necessarily, as in co-pending “System and Method for Warranting Electronic Mail Using a Hybrid Public Key Encryption Scheme” assigned PCT International Publication Number WO 2005/078993, in the present disclosure the participants, be they senders or recipients, do not have access to their private key, if one has been attributed to them, and cannot, therefore, themselves decrypt messages encrypted for them using their matching public key. This is an important departure from most existing email encryption systems where participants possess their own public/private key pair and can themselves use their own private key to decrypt messages encrypted for them using their public key.

Preferably, but not necessarily, as in PCT International Publication Number WO 2005/078993, there is a TTP managing public and private key databases, and the distribution and use of software implementing payload-encryption-packet creation servers and processing servers. The TTP's involvement is key in ensuring that all parties obtain the functionality they expect with regards to end-to-end email encryption, in addition to providing other services such as sender authentication and certified proof-of-delivery.

Also, similarly to PCT International Publication Number WO 2005/078993, both senders and recipients would typically interact with the TTP, and the payload-encryption-packet creation servers and payload-encryption-packet processing servers using a plugin to their email client software. This, therefore, allows users to continue using their email software without modifying their habits.

Preferably, but not necessarily, in addition to the basic functionality outlined above, the sender, or his organization, may choose to mark the message to be encrypted and sent to the recipient in such a way that upon requesting the symmetric key from the TTP's payload-encryption-packet processing server, the TTP will grant the recipient, and the recipient will thereupon receive, a one-time-use reply token or something similar allowing the recipient to log into the TTP's publicly-accessible payload-encryption-packet creation server and encrypt his reply back to the sender. This is especially interesting for senders who want to interact with recipients who are not recognized or otherwise known or identifiable to the TTP.

In sum, the present disclosure is thus composed of:
the payload-encryption-packet creation server,
the payload-encryption-packet processing server,
the software used by the sender and the recipient to interact with the payload-encryption-packet creation servers and payload-encryption-packet processing servers, and
all additional software and hardware required to implement the present disclosure.

Other features of the presently disclosed system and method for providing end-to-end electronic mail encryption will become apparent from the following detailed description taken in conjunction with the accompanying drawings, which illustrate, by way of example, the presently disclosed system and method.

### BRIEF DESCRIPTION OF THE DRAWINGS

A detailed description of preferred embodiments will be given herein below with reference to the following drawings, in which like numbers refer to like elements:

FIG. 1 is a simplified block diagram illustrating an email encryption system according to the present disclosure.

FIG. 2 is a block diagram illustrating an embodiment of an email encryption system according to the present disclosure, wherein the payload-encryption-packet creation trigger module is integrated in a sender station, the payload-encryption-packet creation module is integrated in a payload-encryption-packet creation server, the payload-encryption-packet processing trigger module is integrated in a recipient station, and the payload-encryption-packet processing module is integrated in a payload-encryption-packet processing server.

FIG. 3 is a block diagram illustrating an embodiment of an email encryption system according to the present disclosure, wherein a public key module is integrated in a public key server for providing public keys.

FIG. 4 is a block diagram illustrating another embodiment of an email encryption system according to the present disclosure, wherein the payload-encryption-packet creation trigger module is integrated in the email transmission module and the payload-encryption-packet processing trigger module is integrated in the email reception module.

FIG. 5 is a block diagram illustrating another embodiment of an email encryption system according to the present disclosure, wherein the payload-encryption-packet is sent to the recipient separately from the email.

FIG. 6 is a block diagram illustrating another embodiment of an email encryption system according to the present disclosure, wherein the payload-encryption-packet reception module is integrated in a payload-encryption-packet processing server.

FIG. 7 is a block diagram illustrating another embodiment of an email encryption system according to the present disclosure, wherein the payload-encryption-packet is received at a payload-encryption-packet reception server.

FIG. 8 is a block diagram illustrating another embodiment of an email encryption system according to the present disclosure, wherein the payload-encryption-packet creation trigger module is integrated in a payload-encryption-packet creation trigger server and the payload-encryption-packet processing trigger module is integrated in a payload-encryption-packet reception server.

FIG. 9 is a block diagram illustrating another embodiment of an email encryption system according to the present disclosure, wherein the email is sent to the recipient by a payload-encryption-packet creation server.

FIG. 10 is a block diagram illustrating another embodiment of an email encryption system according to the present disclosure, wherein a payload-encryption-packet creation server and payload-encryption-packet processing server are made to be part of a public payload-encryption-packet services server.

FIG. 11 is a block diagram illustrating another embodiment of an email encryption system according to the present disclosure, wherein a TTP-recognized party interacts with a non-TTP-recognized party.

FIG. 12 is a block diagram illustrating another embodiment of an email encryption system according to the present disclosure, wherein two TTP-recognized parties interact together.

FIG. 13 is a block diagram illustrating the architecture of the Kryptiva™components commercialized by Kryptiva Inc. which implement an embodiment of an email encryption system according to the present disclosure when used in an interaction between a Kryptiva™ member and a Kryptiva™ non-member.

FIG. 14 is a block diagram illustrating the architecture of the Kryptiva™ components which implement an embodiment of an email encryption system according to the present disclosure when used in an interaction between two Kryptiva™ members.

FIG. 15 is a network diagram illustrating an example network layout of the Kryptiva™ components as part of a general-purpose network.

FIG. 16 is a block diagram illustrating a modular view of the Kryptiva™ components' embodiment of an email encryption system according to the present disclosure.

FIG. 17 is a network diagram illustrating an example network layout of the Kryptiva™ components as part of a network where a roaming user needs to access a Kryptiva Packaging Server behind a corporate firewall.

FIG. 18 illustrates user interface for configuring general aspects of the Kryptiva Packaging Plugin.

FIG. 19 illustrates a user interface for configuring the server settings in the Kryptiva Packaging Plugin.

FIG. 20 illustrates the Kryptiva™ menu displayed as part of a user's composition window in a typical email client application.

FIG. 21 illustrates a sample email in payload-encryption format created by the Kryptiva™ components.

FIG. 22 illustrates a the pop-up displayed by the Kryptiva Packaging Plugin for prompting a sender to enter passwords for non-member recipients.

FIG. 23 illustrates a the pop-up displayed by the Kryptiva Packaging Plugin for prompting a recipient for a password for decrypting the sender's email.

FIG. 24 illustrates a high-level flowchart of the operation of the payload-encryption-packet creation trigger module according to the present disclosure.

FIG. 25 illustrates a high-level flowchart of the operation of the payload-encryption-packet creation module according to the present disclosure.

FIG. 26 illustrates a high-level flowchart of the operation of the payload-encryption-packet processing trigger module according to the present disclosure.

FIG. 27 illustrates a high-level flowchart of the operation of the payload-encryption-packet processing module according to the present disclosure.

FIG. 28 illustrates a high-level flowchart of the creation and sending of an email in payload-encryption format by the Kryptiva™ components.

FIG. 29 illustrates a high-level flowchart of the reception and processing of an email in payload-encryption format by the Kryptiva™ components.

### DETAILED DESCRIPTION OF THE PREFERRED EMBODIMENTS

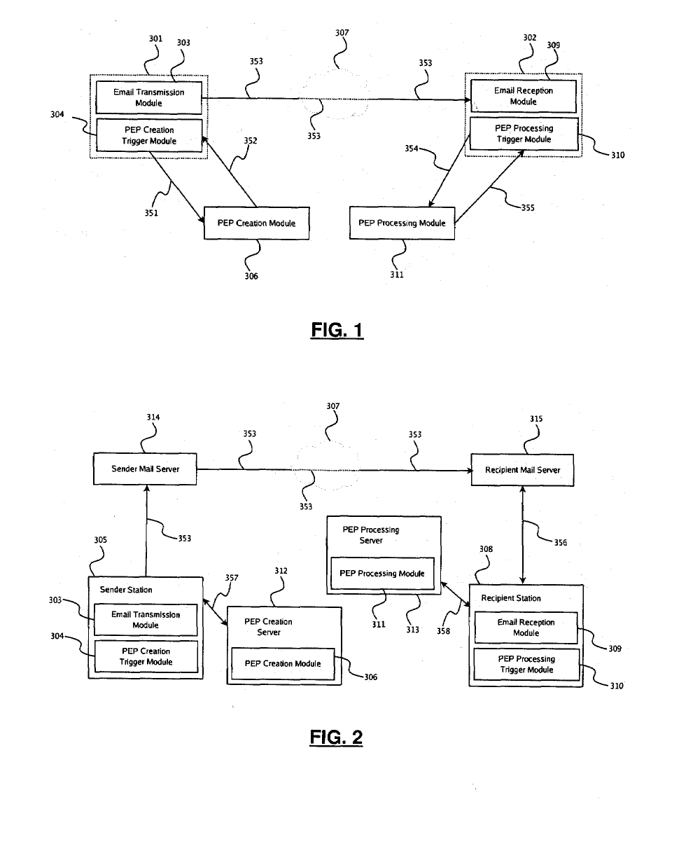

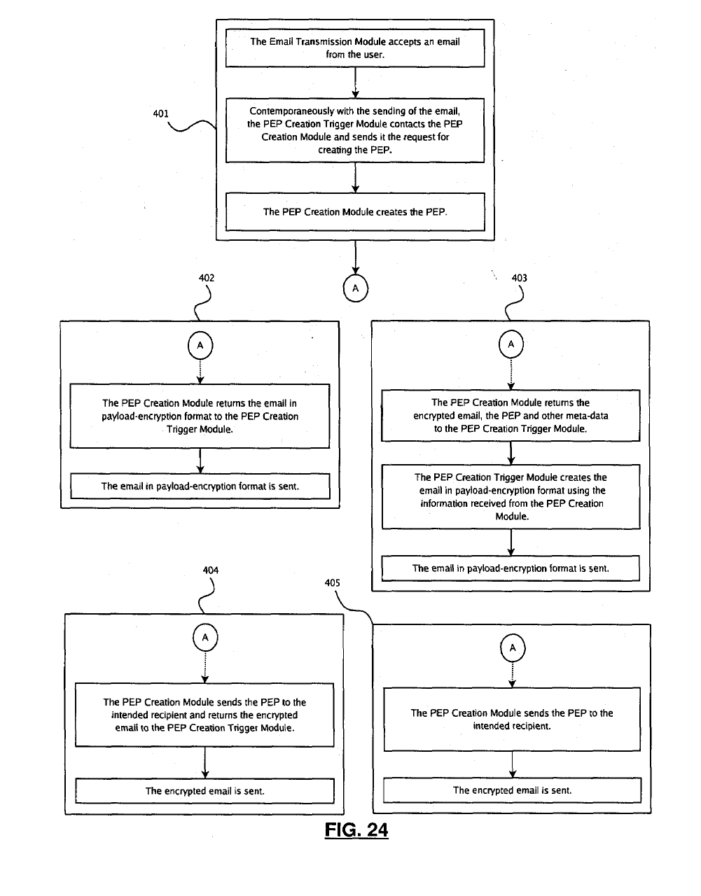

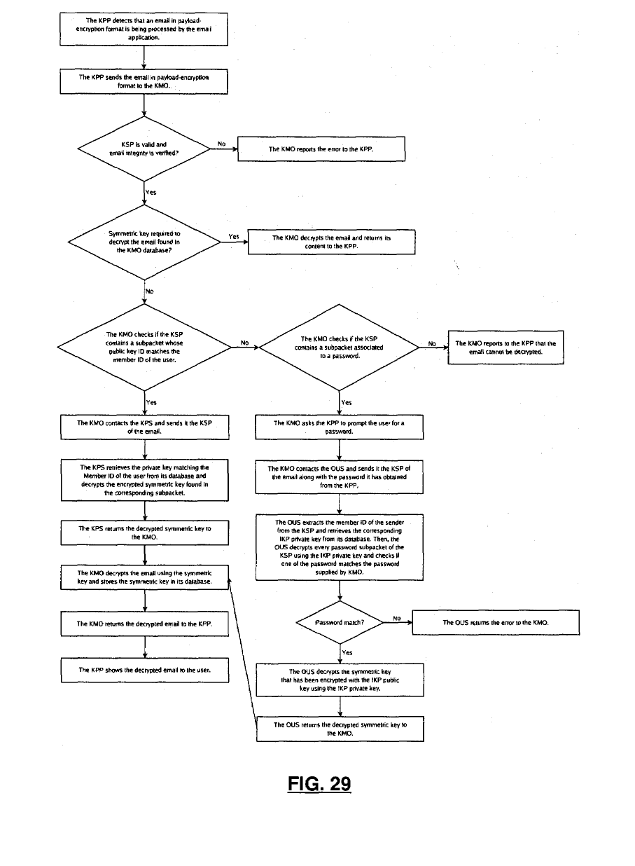

FIG. 1 illustrates the email encryption system of the present disclosure enabling a sender to encrypt an email to a recipient. FIGS. 2 to 12 illustrate possible embodiments of the present disclosure and FIGS. 13 to 23 illustrate the embodiment of the present disclosure by the Kryptiva™ components. FIGS. 24 to 27 illustrate possible embodiments of an email encryption method of the present disclosure. FIGS. 28 and 29 illustrate the embodiment by the Kryptiva™ components of an email encryption method according to the present disclosure.

It is hereby noted that for brevity purposes, figures use the acronym “PEP” instead of “payload-encryption-packet”. All instances of “PEP” should therefore be read in context as “payload-encryption-packet”. For example, “PEP Creation Module” stands for “payload-encryption-packet creation module”. Also, it is worth noting that in FIGS. 1 to 17, dotted boxes are used for presenting components for which interactions of inner components with external components and other inner components are illustrated. Some components presented may be replaced and other may be added without departing from the teachings of the present disclosure. In FIGS. 1 to 17 and 24 to 29, dotted arrows indicate a set of possibilities.

### Overview and Detailed Analysis of Advantages

There are many advantages to the mechanisms embodied in the present disclosure in comparison to existing email encryption systems. These advantages are best explained in the context of the participants' types, be they senders or recipients. There are mainly four types of participants in the present disclosure:

1. Individual user: These are individuals who are known to and registered with the TTP. These users would typically interact with the public payload-encryption-packet services server 322—typically a server, or a set of servers, combining the functionality of a payload-encryption-packet creation server 312 and a payload-encryption-packet processing server 313, and accessible through the public Internet. Individual users typically are attributed a key pair by the TTP which it hosts for them on the public payload-encryption-packet services server 322.
2. Local user: These are users located on a LAN and having access to a privately-hosted local payload-encryption-packet services server 323—typically a server, or a set of servers, combining the functionality of a payload-encryption-packet creation server 312 and a payload-encryption-packet processing server 313, located on an organization's LAN and likely protected by a local firewall, and therefore not directly accessible to any other hosts than those on the LAN. An local payload-encryption-packet services server 323 may host a key pair to which the TTP does not have access to the private key, or it may host a key pair which was attributed by the TTP and is therefore accessible to it, or it may host two or more key pairs, some for which the TTP has access to the private key and some for which it doesn't.
3. Roaming user: These are users who belong to an organization that possesses a local payload-encryption-packet services server 323 but who, for a brief amount of time or for most of the time, are not connected to their organization's LAN. Instead, these users are possibly traveling and must therefore either use the TTP's public payload-encryption-packet services server 322 or have means for accessing their organization's local payload-encryption-packet services server 323. In other words, a roaming user may have his own TTP-hosted key pair, he may have access through the public payload-encryption-packet services server 322 to a key pair matching one found in his organization's local payload-encryption-packet services server 323 or be provided with means for accessing his organization's local payload-encryption-packet services server 323 using some form of remote access such as a VPN or a secure gateway.
4. Non-member: Contrary to an individual user, a local user or a roaming user, any of which are considered to be a “member”, non-members are individuals who are not registered with, identified to, or otherwise known by the trusted third-party (TTP). These users would typically only interact with the PED processing services of the TTP's public payload-encryption-packet services server 322. If, and only if, they were granted a one-time use reply token by the sender, they could also use the PED creation services of the TTP's public payload-encryption-packet services server 322 to encrypt a reply back for the sender. Non-member do not have any key attributed to them. Instead, when content is sent to them, a public key associated to the sender and for which the corresponding private key is accessible by the TTP is used to encrypt the symmetric key which is itself used to encrypt the content of the email sent to them; access to the decrypted symmetric being granted by the TTP as a function of a method based on a sender-provided access token.

As senders, individual users benefit from using the TTP's public payload-encryption-packet services server 322 firstly because they do not need to manage or grasp the underlying principles surrounding the use of private/public key pairs. Instead, they just need to follow the procedure required to use the public payload-encryption-packet services server 322, such as providing a username/password pair. This also simplifies the overall system's usage should, for example, the private/public key pair associated with the user need to be regenerated. In addition, given that the message is encrypted on the TTP's servers, other services, such as proof-of-delivery or sender authentication, can be offered in a simple, easy-to-use, integrated fashion. Of course the underlying premise is that the user must trust the TTP since he will send it his original message unencrypted, but this is the essence of this scheme since other services provided to individuals by the TTP likely include content filtering and certification, possibly a system and method as described in PCT International Publication Number WO 2005/078993. As a “trusted” third-party, the TTP must anyway provide assurances and possibly certification to the effect that it can and does honor users' privacy. Alternatively, individual users who would still prefer not to send content to be encrypted by public payload-encryption-packet services server 322 may choose to enter in agreement with the TTP in order to obtain their own local payload-encryption-packet services server 323. In that case, they would become “local users” with regards to the above description.

As recipients, the individual users benefit from using the TTP's public payload-encryption-packet services server 322 in that they don't need to manage their own private key for decrypting documents, instead they likely have a username/password that allows them to obtain the decrypted symmetric they will need to decrypt a message sent to them. In addition, contrary to the sending process, documents received by the user do not need to be submitted to the TTP for decryption. Instead, only the payload-encryption-packet is submitted by the user to the TTP's payload-encryption-packet processing server 313. Also, it could be possible for the TTP to audit for the user his receiving of encrypted content. Such auditing could be used to detect whether the users' username/password pair may have been compromised and a malicious party is using them to read content sent encrypted to the user.

For an organization, having on-site local payload-encryption-packet services server 323 has many benefits. First, for allowing its users to receive encrypted emails, the organization does not need to create, publish or manage a key pair for every single local user and, for both sending and receiving encrypted emails, there is no need for any user to grasp any of the concepts underlying the use of public-key encryption. Instead, as mentioned earlier, both the sending and receiving of encrypted emails relies on the hosting by the TTP of private/public key pairs.

Senders wishing to send encrypted email to a user belonging to an organization registered with the TTP, for example, would use the public key associated to the organization and hosted by the TTP on its public key servers. Upon receiving emails encrypted using this public key, local users would then use a designated method for authenticating with and using the organization's on-site payload-encryption-packet processing server 313. This may involve using a username/password pair, but it could also be done using other means such as validating that the host from which the payload-encryption-packet processing server 313 is contacted from is indeed on the LAN. Such a process guarantees that only recipients internal to the organization can read email encrypted for this organization. Additionally, the payload-encryption-packet processing server 313 could be configured such that only recipients designated by the sender can obtain the decrypted symmetric key. The net effect of this is that senders can interact with recipients part of an organization without requiring that a recipient take part in any special procedure or his organization to publish a key pair for him. Instead, the decision to allow an internal recipient to read an incoming message can be done at the payload-encryption-packet processing server 313, therefore allowing the organization to centralize the administration of decryption authorization—which, obviously, could be combined with the administration of the local users' rights to obtain other services, such as proof-of-delivery-request generation, message signatures for authentication, or encryption itself.

Much like for decryption, the requirement for local users to use an payload-encryption-packet creation server 312 in order to encrypt outgoing email allows the organization to centralize the control of encryption capabilities. The payload-encryption-packet creation server 312 can therefore be configured to first make sure senders are authorized to use its servers, and then could conduct a number of verifications on the message, some of which could be based on content, designated recipients, and sender's identity, before authorizing the encryption. Again, like for decryption, authorization could be granted based on a username/password pair, a network identifier such as an IP address, or something else.

For a local user to be able to decrypt incoming messages or encrypt outgoing messages, the local payload-encryption-packet services server 323 administrator would likely add him to the list of users recognized by the local payload-encryption-packet services server 323. In order to remove the authorization of a user to encrypt/decrypt, the administrator would, conversely, remove him from the list of users recognized by the local payload-encryption-packet services server 323. Also, it could be possible for the local payload-encryption-packet services server 323 to automatically deactivate users' ability to use its services should any abnormality be detected with regards to a user's behavior, such as attempts to process messages which are determined to contain spam. In that case, a user's account could be quarantined and notification given to the administrator.

Generally, the use of local payload-encryption-packet services server 323 allows an organization to centralize auditing, activity logging, key event notification, policy enforcement, standards-compliance, and all such similar tasks. In addition, organizations could choose to create their own private/public key pairs. In that case, while the public key could be disseminated at large, possibly using the TTP's public key server, only the organization's payload-encryption-packet processing server 313 would be able to decrypt emails sent to local users by remote senders since it would be the only location hosting the corresponding private key. This also means that roaming users would not be able to use public payload-encryption-packet services server 322 to decrypt messages, at the very least not directly. Instead, other capabilities may need to be used, such as VPN access to the organization's LAN or a DMZ 399-based gateway for accessing a local payload-encryption-packet services server 323 behind a firewall.

Generally, roaming users have much of the same advantages as individual users except that they may not have a separate private/public key pair attributed to them. Instead, they may use the same pair attributed to their organization by the TTP and hosted on the public payload-encryption-packet services server 322 and can therefore encrypt and decrypt messages that, typically, could have been processed only by their organization's local payload-encryption-packet services server 323. The ability for roaming users to use public payload-encryption-packet services server 322 allows organizations to have users traveling yet having the same advantages of local users without the organization having to set up any sort of VPN for these roaming users to log into the organization's LAN.

It could be possible to set up roaming users with their own key pair should organizations prefer such users not being able to use the organization's keys through public payload-encryption-packet services server 322. In that case, for a roaming user to receive an encrypted message, it could be made that the symmetric key generated by the sender's payload-encryption-packet creation server 312 be encrypted separately twice, once with the recipient's organization's public key and once with the public key attributed to the roaming user, both encryption results being returned to the sender for sending to the recipient. Upon receipt, the roaming user would then either use the receiving organization's payload-encryption-packet processing server 313, if he is locally connected, or his account on public payload-encryption-packet services server 322 to decrypt the received message.

If roaming users had their own sets of keys, it should be possible for organizations' system administrators to administer accounts for roaming users using, for example, a web interface on public payload-encryption-packet services server 322 or something similar provided by the TTP. It could also be possible for roaming users to access their organization's local payload-encryption-packet services server 323 using a special gateway in their organization's DMZ 399. This gateway and the firewall rules for the DMZ 399 would be configured for being able to forward roaming users' requests to the internal local payload-encryption-packet services server 323.

As recipients, non-members can receive encrypted content without being a participant in any way with the TTP. This is a major departure from existing encryption schemes where sender and recipient must both be participants to the same encryption infrastructure. Since no public key is associated with the recipient, emails sent to the non-member recipients may be encrypted using a public key associated with the sender and a method based on a sender-provided access token, such as a passphrase. Upon receipt, the non-member recipient would contact the TTP's payload-encryption-packet processing server 313 and provide it with both the encrypted symmetric key and the passphrase provided by or agreed upon with the sender. The TTP's payload-encryption-packet processing server 313 would then use the sender's private key and the passphrase along with decryption capabilities and a method based on a sender-provided access token to decrypt the encrypted symmetric key and provide it to the recipient. Given that the symmetric key was encrypted with the senders public key, it would be practically impossible for an intercepting party to decrypt the emails using brute-force techniques, which could have been easier if the email had been only encrypted using a passphrase. As an extra precaution, the TTP's payload-encryption-packet processing server 313 could be configured to not allow more than a handful of decryption attempts on any given message by non-member recipients.

To facilitate interaction with non-member recipients, senders could be provided with facilities for storing recipient-specific passphrases either on the designated payload-encryption-packet creation server 312 or locally on their machine. This would allow senders to interact with non-member recipients without having to provide a passphrase every time. In other circumstances, such as for banks providing online access to customer accounts, it may be desirable to allow non-member recipients to select their own passphrases using a web interface. In that case, the non-member recipient would be able to select his own passphrase without the actual sender having to select one for or agree upon one with the non-member recipient. Capabilities would be provided for the sender's system or the payload-encryption-packet creation server 312 to automatically retrieve the passphrase for a given non-member recipient.

As mentioned earlier, it would be possible to send non-members specially-marked encrypted emails that upon being decrypted by the TTP's payload-encryption-packet processing servers 313 would result in the non-member recipient being able to log into the TTP's payload-encryption-packet creation servers 312 and encrypt a reply back to the original sender. Again, this is a major departure from existing encryption schemes where non-members are typically directed to a website for reading encrypted content and replying back to the original sender. The system presented in the present disclosure therefore allows non-member recipients to continue using their existing email client software while still being able to entertain a secure email exchange with a sender recognized by the TTP.

### First Set of Embodiments

Referring to FIG. 1, the system comprises an email transmission module 303 for sending an email, an email reception module 309 for receiving the email, a payload-encryption-packet creation trigger module 304 for triggering a request for creating a payload-encryption-packet, a payload-encryption-packet creation module 306 for creating the payload-encryption-packet, a payload-encryption-packet processing trigger module 310 for triggering the request for processing a payload-encryption-packet, and a payload-encryption-packet processing module 311 for processing a payload-encryption-packet. Preferably, but not necessarily, the email transmission module 303 and the payload-encryption-packet creation trigger module 304 are aggregated together, possibly along with other modules, into a sender unit 301. Similarly, the email reception module 309 and payload-encryption-packet processing trigger module 310 are aggregated together, possibly along with other modules, to form a separate recipient unit 302. The payload-encryption-packet creation module 306 and the payload-encryption-packet processing module 311, on the other hand, can either be separate and independent from one another or integrated together within another module. Furthermore, while the payload-encryption-packet creation trigger module 304 may be connected to a module integrating a payload-encryption-packet creation module 306 and a payload-encryption-packet processing module 311, the payload-encryption-packet processing module 311 may be connected to yet another separate module integrating a payload-encryption-packet creation module 306 and a payload-encryption-packet processing module 311. Regardless or their integration or aggregation into other modules, the payload-encryption-packet creation module 306 and payload-encryption-packet processing module 311 operate remotely from the sender unit 301 and the recipient unit 302. With regards to the use of the term “remotely”, it is hereby noted that for a unit designated as “unit A” to operate “remotely” from a unit designated as “unit B”, then data would need cross over a network interface, or an interface similar to a network interface like a USB or FireWire® interface, if it were to be transferred back and forth between unit A and unit B; in other words, the services, resources, and/or interfaces of unit B could only be accessed by unit A via a network.

The email is typically sent from the sender unit 301 to the recipient unit 302 (arrow 353), possibly using a network 307. Contemporaneously with the sending of the email by the email transmission module 303, the payload-encryption-packet creation trigger module 304 contacts the payload-encryption-packet creation module 306 and sends it a request for creating a payload-encryption-packet 351. The payload-encryption-packet creation module 306 creates the payload-encryption-packet and returns it to the payload-encryption-packet creation trigger module 304 (arrow 352). Contemporaneously with the creation of the payload-encryption-packet, the email is encrypted and the outgoing email is substituted with the encrypted email. Contemporaneously with the reception of the payload-encryption-packet by the recipient unit 302, the payload-encryption-packet processing trigger module 310 contacts the payload-encryption-packet processing module 311 and sends it a request for processing the payload-encryption-packet 354. The payload-encryption-packet processing module 311 then processes the payload-encryption-packet and extracts decryption information. The payload-encryption-packet processing module 311 then sends back the decryption information to the payload-encryption-packet processing trigger module 310 (arrow 355), thereby enabling a recipient to decrypt and view the content of the encrypted email.

In one embodiment, the payload-encryption-packet creation trigger module 304 sends the email and meta-data about the email as part of the request for creating a payload-encryption-packet 351 to the payload-encryption-packet creation module 306. The payload-encryption-packet creation module 306 then generates a symmetric key, possibly using a random number generator or a pseudo random-number generator and encrypts the email with the symmetric key.

The payload-encryption-packet creation module 306 then encrypts the symmetric key at least once for each recipient, or group of recipients, with each encryption being done separately according to the following rules:
if a public key is available for a recipient or a group of recipients, the symmetric key is encrypted using that public key, and
if no public key is available for a recipient or a group of recipients, the symmetric key is encrypted using a public key associated with the sender for which the payload-encryption-packet processing module 311 has access to the corresponding private key, and recipient access token is generated for later enabling the payload-encryption-packet processing module 311 to selectively provide a decrypted copy of the symmetric key to those recipients authorized to that effect using a method based on a sender-provided access token.

The payload-encryption-packet creation module 306 then generates a payload-encryption-packet as a function of the encrypted symmetric key, or the entire set of encrypted symmetric keys, and, possibly, additional meta-data, including recipient access token if such information exists, combines the encrypted email, the payload-encryption-packet and, possibly, further meta-data thereby generating an email in payload-encryption format, and returns the email in payload-encryption format to the payload-encryption-packet creation trigger module 304 (arrow 352). The email in payload-encryption format could have also been created by the payload-encryption-packet creation trigger module 304, provided the payload-encryption-packet creation module 306 would have returned to it the encrypted email, the payload-encryption-packet and all additional information, such as meta-data, necessary for generating the email in payload-encryption format. With the email in payload-encryption format created, the original email is then substituted with the email in payload-encryption format and sent by the email transmission module 303 (arrow 353).

It could also be possible for the payload-encryption-packet creation module 306 to return the symmetric key generated asis back to the payload-encryption-packet creation trigger module 304 along with the payload-encryption-packet. The payload-encryption-packet creation trigger module 304 would then create the encrypted email using that symmetric key and the email in payload-encryption format using the encrypted email and the payload-encryption-packet. In that case, however, the payload-encryption-packet may need to include, or be aggregated with, some form of cryptographic hash of the email and there may need to be some form of signing of the payload-encryption-packet, possibly using a system and method similar to that presented in International Application Number PCT International Publication Number WO 2005/078993, in order to ensure that there is a match between the email for which the payload-encryption-packet was created and the encrypted email received by a recipient. Such signing may also be forfeited.

At reception, the payload-encryption-packet is extracted from the email in payload-encryption format and sent by the payload-encryption-packet processing trigger module 310 to the payload-encryption-packet processing module 311 (arrow 354), possibly along with recipient access token. The payload-encryption-packet processing module 311 preferably first verifies that the payload-encryption-packet processing trigger module 310 does indeed have the right to use the payload-encryption-packet processing module's 311 services. The payload-encryption-packet processing module 311 then possibly verifies the payload-encryption-packet's validity, say by verifying a signature, possibly using a system and method similar to that presented in PCT International Publication Number WO 2005/078993. The payload-encryption-packet processing module 311 then follows the following rules for returning a decrypted copy of the encrypted symmetric key found in the payload-encryption-packet:
if a public key associated with the recipient was used to encrypt the symmetric key, the payload-encryption-packet processing module 311 then retrieves the private key matching said public key—possibly from a private key database, possibly using meta-data included in the payload-encryption-packet to identify the key associated to the recipient—, decrypts the encrypted symmetric key found in the payload-encryption-packet, and returns the symmetric key to payload-encryption-packet processing trigger module 310 (arrow 355).
if a public key associated with the sender was used to encrypt the symmetric key and a method based on sender-provided access tokens is used to authorize recipients to obtain access to the decrypted key, the payload-encryption-packet processing module 311 retrieves the private matching said public key, possibly in a fashion similar to that described in the previous paragraph, uses the recipient access token provided by the payload-encryption-packet processing trigger module 310 to enable access to the decrypted symmetric key according to the method based on sender-provided access tokens, decrypts the encrypted symmetric key found in the payload-encryption-packet, and returns the symmetric key to the payload-encryption-packet processing trigger module 310 (arrow 355).

The symmetric key can then be used to decrypt the encrypted email received as part of the email in payload-encryption format. The email in its original format (its format prior to being processed by the payload-encryption-packet creation module 306) would then be available for a recipient to read.

The type of meta-data included by the payload-encryption-packet creation module 306 may include any information that may be relevant to the sender, his organization, the email being sent, the type of content being included, details regarded how, when or how the payload-encryption-packet was created, etc. Here are a few examples: the sender's email address, the list of recipient addresses, a serial number uniquely identifying the payload-encryption-packet, the time at which the payload-encryption-packet was created, an expiry date for the payload-encryption-packet after which the payload-encryption-packet processing module 311 should refuse to process it, a unique identifier for identifying the payload-encryption-packet creation module 306 used to created the payload-encryption-packet, the format of the encrypted email, the monetary value of the content of the encrypted email, and web URLs. It will be evident to those skilled in the art that other data may be included in the meta-data included by the payload-encryption-packet creation module 306 without departing from the teachings of the present disclosure.

With regards to the method based on a sender-provided access token and the corresponding recipient access token, they can be implemented in a number of ways. For example, a cryptographic algorithm that uses a string as a symmetric key could be used to re-encrypt the symmetric key that was already encrypted with a public key by the payload-encryption-packet creation module 306. This would then require the payload-encryption-packet processing module 311 to have access to the same string in order to retrieve the public-key-encrypted symmetric key from the payload-encryption-packet. Another way to implement the method based on a sender-provided access token is to require that the sender select a certain set of images which the recipient would need to select in order to be successfully authorized by the method based on a sender-provided access token. Yet another way to implement the method based on a sender-provided access token is to create a one-way hash of a password using a cryptographic hash algorithm such as SHA-1 or SHA-256 and aggregate that hash to the encrypted symmetric key at payload-encryption-packet creation on the payload-encryption-packet creation module 306. In that case, the payload-encryption-packet processing module 311 would either be provided with the clear-text password by the payload-encryption-packet processing trigger module 310 or a cryptographic hash of it, and it would verify that there is a match with the cryptographic hash found in the payload-encryption-packet. If the hash matches, it would go ahead and decrypt the encrypted symmetric key and provide it to the payload-encryption-packet processing trigger module 310, otherwise it would inform the payload-encryption-packet processing trigger module 310 that the recipient access token provided does is not valid. Also, the cryptographic hash in the payload-encryption-packet could itself be encrypted for further security.

Preferably, but not necessarily, an organization operating as a TTP would be providing payload-encryption-packet creation modules 306 and payload-encryption-packet processing modules 311 to client organization. The operating organization would either create a key pair for each payload-encryption-packet creation module 306 and payload-encryption-packet processing module 311 provided to a client organization or let the client organization generate its own key pair and providing the operating organization with the corresponding public key, or both approaches could be used. In the latter case, the operating organization hosts at least two public keys for the client organization; said organization having access to the private key corresponding to one of those two key pairs. In addition the operating organization could provide access to a public payload-encryption-packet services server 322 to non-member recipients of client organizations.

Typically, the sender unit 301 is any system, device, workstation, server, appliance, computing platform, or hardware capable of transmitting email, regardless of whether it has an active user directly interacting with it at any point in time. One embodiment of the sender unit 301, a sender station 305, is a typical computer system including hardware such as a CPU, or set of tightly-coupled CPUs, RAM, flash, buses, bus controller or controllers, network interface, peripherals and other hardware components, and configured for running software such as an operating system and applications. The sender station 305 may be a fixed computer devices such as a PC workstation running a popular operating system, such as Windows®, MacOS®, or Linux®, or it may be a portable device such as a Blackberry®, Palm® Treo™, or a generic device running an embedded operating system, such as Symbian® or Windows® Mobile™, or it may be a server system, or a set of aggregated servers, running a server operating system, such as Windows® Server or Red Hat® Linux®, or it may be any such similar system.

Similarly to the sender unit 301, the recipient unit 302 may be any system, device, workstation, server, appliance, computing platform, or hardware capable of transmitting email, regardless of whether it has an active user directly interacting with it at any point in time. One embodiment of the recipient unit 302 is a recipient station 308 having similar characteristics as the sender station 305.

FIG. 2 illustrates another embodiment of the email encryption system according to the present disclosure. In this embodiment, the email transmission module 303 and the payload-encryption-packet creation trigger module 304 are integrated in the sender station 305 and the email reception module 309 and payload-encryption-packet processing trigger module 310 are integrated in the recipient station 308. In this case, the email transmission module 303 and email reception module 309 may be any application capable of sending and/or receive email. This includes typical email client applications used by users to retrieve/read/send email, such as Eudora®, Outlook®, Mozilla Thunderbird™, Lotus® Notes, and others. The email transmission module 303 and email reception module 309 may also be a web browser, such as Internet Explorer™ or Mozilla Firefox™, when said web browser is being used by a user to access an online web-mail account, such as Yahoo!® Mail, Hotmail™, Gmail™, and others. The email transmission module 303 may also be server software configured for sending email in an automated fashion, such as a website script or program configured for sending email in response to a command, or a series of commands, effected by a user on a website or a server script configured for sending email to notify the recipient of some critical event on the server. Conversely, the email reception module 309 may be a server software configured for receiving and processing email in an automated fashion, such as a mailing list subscribing software or a script for processing incoming user complaints or feedback.

Still in this embodiment, the payload-encryption-packet creation trigger module 304 is software running alongside the email transmission module 303 on the sender station 305, possibly interfacing with the email transmission module 303 in order to create payload-encryption-packets for all or some of the outgoing emails. Similarly, the payload-encryption-packet processing trigger module 310 is software running alongside the email reception module 309 on the recipient station 308, possibly interfacing with the email reception module 309 in order to process some or all of incoming emails in payload-encryption format. Typically, the payload-encryption-packet creation trigger module 304 and payload-encryption-packet processing trigger module 310 would be add-on software to the email transmission module 303 and email reception module 309, respectively. The payload-encryption-packet creation trigger module 304 and payload-encryption-packet processing trigger module 310 may, for example, be implemented as plugins to email clients and web browsers, or be implemented as extensions to server software. The extent and fashion of the integration and interaction between the payload-encryption-packet creation trigger module 304 and the email transmission module 303 and the payload-encryption-packet processing trigger module 310 and the email reception module 309 may vary greatly without departing from the teachings of the present disclosure. For example, the payload-encryption-packet creation trigger module 304 may be an integral part of the email transmission module 303 and the payload-encryption-packet processing trigger module 310 may be an integral part of the email reception module 309 as in FIG. 4. Also, the payload-encryption-packet creation trigger module 304 and the payload-encryption-packet processing trigger module 310 may be implemented as the same plugin, wherein the plugin's functionality depends on whether it is used to create payload-encryption-packets for outgoing email or to process incoming payload-encryption-packets or incoming emails in payload-encryption format. The payload-encryption-packets generated by payload-encryption-packet creation modules 306 would likely contain plain-text messages so that recipients that lack the software required to deal with payload-encryption-packets could still be informed of the functionality and how they could obtain the software required to deal with payload-encryption-packets and emails in payload-encryption format.

Still in the embodiment illustrated in FIG. 2, the payload-encryption-packet creation module 306 is integrated in a payload-encryption-packet creation server 312 and the payload-encryption-packet processing module 311 is integrated in a payload-encryption-packet processing server 313. The payload-encryption-packet creation server 312 may either be on the local network of the sender station 305 or be outside the perimeter of the local firewall. Similarly, the payload-encryption-packet processing server 313 may either be on the local network of the recipient station 308 or be outside the perimeter of the local firewall. Typically, the location of the payload-encryption-packet creation server 312 and payload-encryption-packet processing server 313 being used depends on the factors mentioned earlier, such as which type of person is accessing the server, whether it be an individual user, a local user, a roaming user or a non-member. The location and actual system configuration or layering of the payload-encryption-packet creation server 312 and payload-encryption-packet processing server 313 do not modify their behavior. Typically, however, the sender station 305 is connected to the payload-encryption-packet creation server 312 and the recipient station 308 is connected to the payload-encryption-packet processing server 313. Generally these connections are by way of a network interface, but other configurations are also possible such as using a peripheral bus like USB or FireWire®. There is, in fact, nothing precluding the payload-encryption-packet creation server 312 or the payload-encryption-packet processing server 313 from being a device attached to the sender station 305 via a USB bus.

Generally, both the payload-encryption-packet creation server 312 and payload-encryption-packet processing server 313 are running a hardened operating system such as Linux®, Solaris® or AIX®. As such, the payload-encryption-packet creation module 306 and payload-encryption-packet processing module 311 are typically implemented as software using the secure socket layer (SSL) API to receive and respond to outside requests, and operating system APIs for spawning tasks and threads and controlling the execution of threads and processes servicing existing requests. Furthermore, the software implementation of the payload-encryption-packet creation module 306 and the software implementation of the payload-encryption-packet processing module 311 may interact with local services such as syslog for logging key events and use a database for storing and retrieving data. Said database could be used for adding functionality to the basic architecture of the present disclosure. Typically, both the payload-encryption-packet creation module 306 software and payload-encryption-packet processing module 311 software operate automatically without requiring direct human intervention on the server running the software, though software or interfaces may be provided for facilitating the set up of such software and servers. Also, the software implementation of the payload-encryption-packet creation module 306 and the software implementation of the payload-encryption-packet processing module 311 use a cryptographic library for implementing the cryptographic functionality associated with payload-encryption-packets.

Still in the embodiment illustrated in FIG. 2, the payload-encryption-packet creation trigger module 304 is activated contemporaneously with the sending of the email by the email transmission module 303. If the payload-encryption-packet creation trigger module 304 is a plugin to an email client application 328 for example, the payload-encryption-packet creation trigger module 304 would be activated when the user would click on the “Send” button of his email client application 328. Because the actual time at which an email is truly “sent” by the sender station 305 could, nevertheless, be subject to interpretation, it is assumed in this embodiment that the email leaving the sender station 305 for the sender mail server 314 has been processed for encryption if it needed to be. The payload-encryption-packet creation trigger module 304 communicates with the payload-encryption-packet creation server 312 (arrow 357) to create an email in payload-encryption format and substitutes the outgoing email with the email in payload-encryption format which is then itself sent to the sender mail server 314 from the sender station 305. The sender mail server 314 then transmits the email in payload-encryption format to the recipient mail server 315, possibly through a network 307 or a set of interlinked networks and mail servers. The email is then retrieved from the recipient mail server 315 by the email reception module 309 (email “pull”) or sent by the recipient mail server 315 to the recipient station 308 (email “push”).

Typically, the payload-encryption-packet processing trigger module 310 software interacts with the email reception module 309 software to detect incoming email in payload-encryption format. If the payload-encryption-packet processing trigger module 310 is a plugin, for example, this may involve the payload-encryption-packet processing trigger module 310 hooking itself into the receive functionality of the email client application 328 or hooking itself on the email client application 328 functionality for adding incoming emails to email existing folders. Having determined that an incoming email is an email in payload-encryption format, the payload-encryption-packet processing trigger module 310 typically extracts the payload-encryption-packet from the email in payload-encryption format and communicates with the payload-encryption-packet processing server 313 (arrow 358) in order to obtain a decrypted copy of the encrypted symmetric key found in the payload-encryption-packet. Using the returned symmetric key, the payload-encryption-packet processing trigger module 310 can then decrypt the encrypted email found in the email in payload-encryption format and make it available either directly to the recipient or make it available to the email reception module 309 which would then be used by the recipient to process and view the email.

In order to return the symmetric key found in encrypted form in the payload-encryption-packet, the payload-encryption-packet processing module 311 running on the payload-encryption-packet creation server 312 would typically first verify the integrity of the payload-encryption-packet, possibly by verifying its authenticity as explained earlier. The payload-encryption-packet processing module 311 would then retrieve the private key matching the public key used to encrypt the symmetric key during the packaging of the payload-encryption-packet, possibly use recipient access token for enabling access the decrypted symmetric key according to a method based on sender-provided access tokens, and decrypt the encrypted symmetric key. This functionality of the payload-encryption-packet processing module 311 may further be combined to other functionalities.

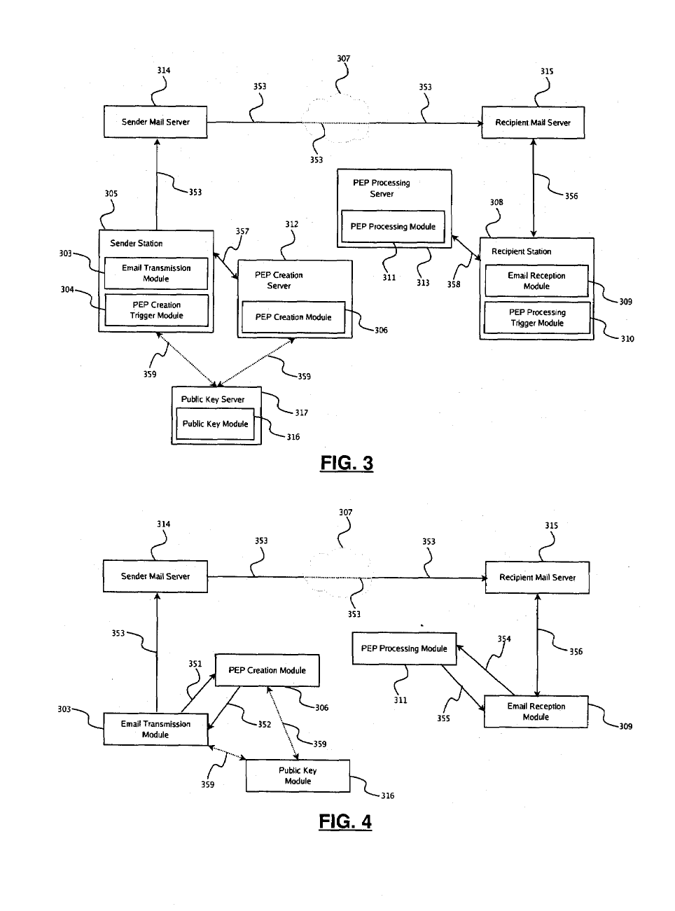

Referring to the embodiment illustrated in FIG. 3, the system further comprises a public key module 316 part of a public key server 317 for providing public keys to either the payload-encryption-packet creation trigger module 304 or the payload-encryption-packet creation module 306 or both. Typically, the public key server 317 is hosted, operated and administered by a TTP, possibly the same one providing the software for the payload-encryption-packet creation server 312 and payload-encryption-packet processing server 313 or providing remote access to a public payload-encryption-packet services server 322. The public key server 317 is typically a system such as the ones described above for the payload-encryption-packet creation server 312 and the payload-encryption-packet processing server 313. The public key module 316 running on the public key server 317 is typically connectable to a public key database. Upon receiving a request for finding a recipient's public key, it consults the database and provides the key back to the requester 359. It is possible for the keys to be signed in a fashion similar to that used by a Certificate Authority to issue certificates or in a different fashion in order to allow the requester to verify the validity of the key. It is also possible that the connection to the public key server 317 is secured using a protocol such as SSL in order to allow authentication of the keys returned by the public key server 317 by means of authenticating the public key server 317 itself. Procedures for having a key made accessible by the public key server 317 may include having to enroll as part of a subscription with the TTP operating the public key server 317, purchasing a product or simply filling out an online form.

Referring to the embodiment illustrated in FIG. 4, the email transmission module 303 integrates the functionality typically implemented by the payload-encryption-packet creation trigger module 304 and the email reception module 309 integrates the functionality typically implemented by the payload-encryption-packet processing trigger module 310. Also, the payload-encryption-packet creation module 306 operates remotely from the email reception module 309 and the payload-encryption-packet processing module 311 operates remotely from the email reception module 309. In addition a public key module 316 is accessible for providing public keys by either the email transmission module 303 or the payload-encryption-packet creation module 306 or both.

In this embodiment, the email transmission module 303 contacts the payload-encryption-packet creation module 306 in order to encrypt a message for a recipient or a list of recipients 351. First, the email transmission module 303 must provide the proper information in order to obtain the authorization to use the payload-encryption-packet creation module 306. This information may be a username/password pair, or it may be a function of the network layout, such as an IP address or a MAC address, or both, or something else. The payload-encryption-packet creation module 306 may also be configured to accept connections from any email transmission module 303 with access to it. In the case of the email transmission module 303 of a non-member having received a one-time-use reply token, the authorization procedure would require providing the token to the payload-encryption-packet creation module 306, thereby typically using it up and rendering it unusable for future reuse. Having been authorized to use the payload-encryption-packet creation module 306's services, the email transmission module 303 transmits the message to be encrypted for the sender's recipient or recipients to the payload-encryption-packet creation module 306. Note that the payload-encryption-packet creation module 306 could be located on a the same LAN as the email transmission module 303 or it could be remotely accessible through another network such as the Internet. The functionality of the payload-encryption-packet creation module 306 should be fairly similar whether it is on the local LAN or on a remote network.

The payload-encryption-packet creation module 306 first receives the message from the email transmission module 303 and likely stores it in a temporary buffer in RAM for further processing. The payload-encryption-packet creation module 306 could then conduct a series of analysis on the message, including verifying compliance to corporate guidelines and spam detection, amongst other possibilities. Having done so, the payload-encryption-packet creation module 306 generates a random key and encrypts the message with this key.

The payload-encryption-packet creation module 306 then conducts a series of operations to locate and select a public key or a set of public keys for encrypting the symmetric key for the recipient or recipients. First, the server checks whether a public key has been published for the actual recipient and then checks whether a public key has been published for the recipient's organization (possibly based on the domain name found in the recipient's email address.) The order and extent of these checks could be configurable. For example, the payload-encryption-packet creation module 306 could be made to first look in a local cache, which could contain entries with a time-to-live, or it could be made to look in a statically-populated database, or even required to retrieve the public key every time an encryption request is made. Whenever the payload-encryption-packet creation module 306 would need to locate a key for a recipient it does not have a key for locally, it would typically contact a public key server 359, possibly the one hosted by the TTP. It is also possible that the payload-encryption-packet creation module 306 could be configured to permit the email transmission module 303 to designate which public key to use for the recipients or in which way the recipients' public keys can be determined or retrieved.

Should no key be located for the recipient, the payload-encryption-packet creation module 306 may interact with the email transmission module 303 to encrypt the symmetric key using the public key attributed to the sender and restrict access to the decrypted symmetric key using a method based on a sender-provided access token, such as the passphrase mentioned earlier, which would typically be provided by the sender. The selection, storage, and retrieval of the recipient access token required for enabling access to the decrypted symmetric key could, of course, be automated and the non-member recipient could, as explained earlier, be made to participate in the selection of an associated passphrase. At this stage, the sender could typically be prompted by the email transmission module 303 whether he wants the non-member recipient to receive a one-time-use reply token for being able to reply back in an encrypted fashion, as described earlier.

Having found the relevant public key or keys, or having determined that the recipient is a non-member and that a method based on a sender-provided access token will be used in addition to the sender's public key, the payload-encryption-packet creation module 306 encrypts the randomly-generated symmetric key appropriately, possibly multiple times, possibly once for each recipient. The payload-encryption-packet creation module 306 then generates a payload-encryption-packet by aggregating the encrypted symmetric key along with other data, possibly data that is itself encrypted.

The payload-encryption-packet creation module 306 could also conduct a number of other operations on the message, such as generating a signature for the sender akin to the description found in co-pending PCT International Publication Number WO 2005/078993, or it may create a proof-of-delivery-request for the message so that the recipient would not be able to read the message's content without confirming receipt back to the sender. With regards to encryption, proof-of-delivery and signature, the preferred order would typically be: create proof-of-delivery-request, encrypt for recipient, and sign. This would allow recipients to first validate the origin (which is the least expensive of operations in terms of required computational power), then proceed with the other operations. This is unique to the present disclosure as encryption and signature can be atomically conducted on the payload-encryption-packet creation module 306. In other encryption systems, content certification is sometimes typically only done on non-encrypted content, and therefore signing is conducted before encryption, which requires recipients to conduct the more expensive operation (decryption) first before being able to verify the email's origin. Additionally, given that in the present disclosure recipients must first decrypt before taking care of proof-of-delivery, senders can be sure that recipients do indeed have a readable message after the processing of the proof-of-delivery, instead of possibly a message for which a proof-of-delivery was triggered but that the recipient may turn out to be unable to decrypt. The payload-encryption-packet creation module 306 could also be made to conduct a number of auditing procedures as described above.

The payload-encryption-packet creation module 306 then returns the encrypted message and the payload-encryption-packet to the email transmission module 303 (arrow 352). The email transmission module 303 then transmits the encrypted message and the payload-encryption-packet as a regular email to the sender mail server 314 (arrow 353). In turn, the sender mail server 314, transmits the email to the recipient mail server 315 (arrow 353).

Next, the email reception module 309 retrieves messages stored for it by the recipient mail server 315 (arrow 356). It is at this stage that the email reception module 309 would detect emails containing payload-encryption-packets and act appropriately. Then the email reception module 309 contacts a payload-encryption-packet processing module 311 354 and sends it a request for processing a payload-encryption-packet in order to obtain a decrypted copy of the symmetric key used to encrypt the email he has received. If it is recognized by the payload-encryption-packet processing module 311 and, therefore, a public key associated with the recipient to which it belongs was used by the sender's payload-encryption-packet creation module 306 to encrypt the designated symmetric key, the email reception module 309 would typically have to first be authorized by the payload-encryption-packet processing module 311 to use its services, typically using the methods described above such as using a username/password pair. If the email reception module 309 belongs to a non-member recipient that is, therefore, not recognized by or known to the payload-encryption-packet processing server 313, the recipient would likely need to provide the payload-encryption-packet processing server 313 with the recipient access token required by the payload-encryption-packet processing module 311 to enable access to the decrypted symmetric key. This request could possibly be in the form of a pop-up to the user requesting a passphrase or password, or, it the non-member recipient often interacts with the same sender, the agreed-upon recipient access token could be stored locally by the email reception module 309 retrieved as needed for decrypting incoming messages from the given sender.

The payload-encryption-packet processing module 311 processes the request for processing a payload-encryption-packet obtained from the recipient. If the recipient is registered with or otherwise known to the payload-encryption-packet processing module 311, the payload-encryption-packet processing module 311 retrieves the private key associated with the recipient from a database and uses the retrieved key to decrypt the encrypted symmetric key. If the recipient is a non-member, the payload-encryption-packet processing module 311 identifies the private key associated with the sender, retrieves this key from a database, uses the recipient access token provided by the email reception module 309 to enable access to the decrypted symmetric key, and uses the private key to decrypt the randomly-generated symmetric key originally used by the sender's payload-encryption-packet creation module 306 to encrypt the sender's message. Should the encrypted randomly-generated symmetric key used by the sender's payload-encryption-packet creation module 306 to encrypt the sender's message be specially-marked, the payload-encryption-packet processing module 311 would make available a one-time-use reply token that could later be used by the non-member recipient's email reception module 309 to log into a payload-encryption-packet creation module 306 and encrypt a reply back to the sender.

The payload-encryption-packet processing module 311 could, of course, be made to conduct various operations in reaction to requests for processing payload-encryption-packets. For example, as alluded to earlier, it could check to make sure that the recipient associated with the email reception module 309 sending the request for processing the payload-encryption-packet is indeed part of the list of recipients originally designated by the sender. In addition, the payload-encryption-packet processing module 311 could be made to conduct many tasks related to auditing, report generation, incident reporting and the likes such as recording email reception module's 309 requests for processing payload-encryption-packets along with who is sending encrypted content to the recipient. Much of the payload-encryption-packet processing module 311's behavior could of course be configurable.

The payload-encryption-packet creation module 306 then transfers the decrypted symmetric key to the email reception module 309. Having received the decrypted symmetric key, the email reception module 309 can then decrypt the message and make it available to a recipient. Should the sender's email transmission module 303 have marked the message for allowing the recipient to reply back in an encrypted fashion, the email reception module 309 would also receive a one-time-use reply token for logging into a payload-encryption-packet creation module 306 for encrypting the recipient's reply back to the sender.

With regards to one-time-use reply tokens, there are several ways in which this can be implemented. Preferably, but not necessarily, there is an encryption token module 346 accessible to the payload-encryption-packet creation trigger module 304 for requesting a token prior to the email transmission. The encryption token module 346 could be made to require the member to authenticate with it in some way prior to giving it a token. The token could then be included as part of the encrypted content sent to the recipient for retrieval by the latter upon successful decryption. The encryption token module 346 could also be integrated in the payload-encryption-packet processing module 311 for providing the token to the payload-encryption-packet processing trigger module 310 after the successful processing of a payload-encryption-packet. The token could be an opaque identifier created randomly by the encryption token module 346 when a token is requested from it and stored in a database for a certain amount of time until it is “consumed” by the recipient through a reply, thereby deleting it from the database.

In addition and as a complement to other descriptions to that effect in the present disclosure, it is hereby noted the request for creating a payload-encryption-packet 351 may include, amongst other possible data items, the following: the email for which a payload-encryption-packet is to be created along with all of its fields, an expiry date after which the payload-encryption-packet should not be requested by the payload-encryption-packet processing module 311, a set of public keys, possibly one for each recipient, a set of passwords, possibly one for each recipient, a one-time-use reply token for inclusion in the payload-encryption-packet, and all other data items relevant or required for implementing an embodiment of the present disclosure. Similarly, it is hereby noted the request for processing a payload-encryption-packet 354 may include, amongst many other data items, the following: the payload-encryption-packet to be processed, authentication information for the payload-encryption-packet module 311 to ensure that the recipient is indeed authorized to use its services, the recipient access token (passphrase) as it is known to him, the IP address of the recipient, and all other data items relevant or required for implementing an embodiment of the present disclosure.

### Second Set of Embodiments

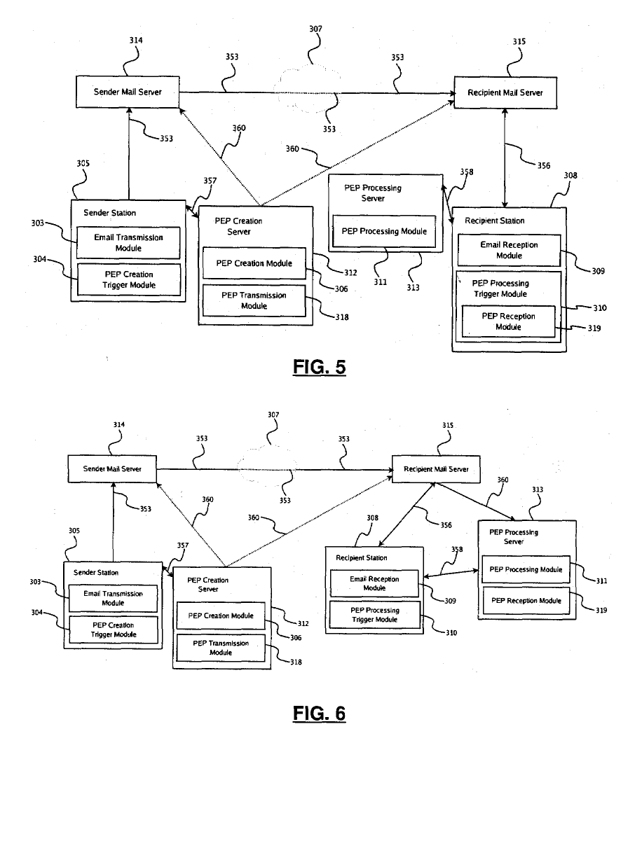

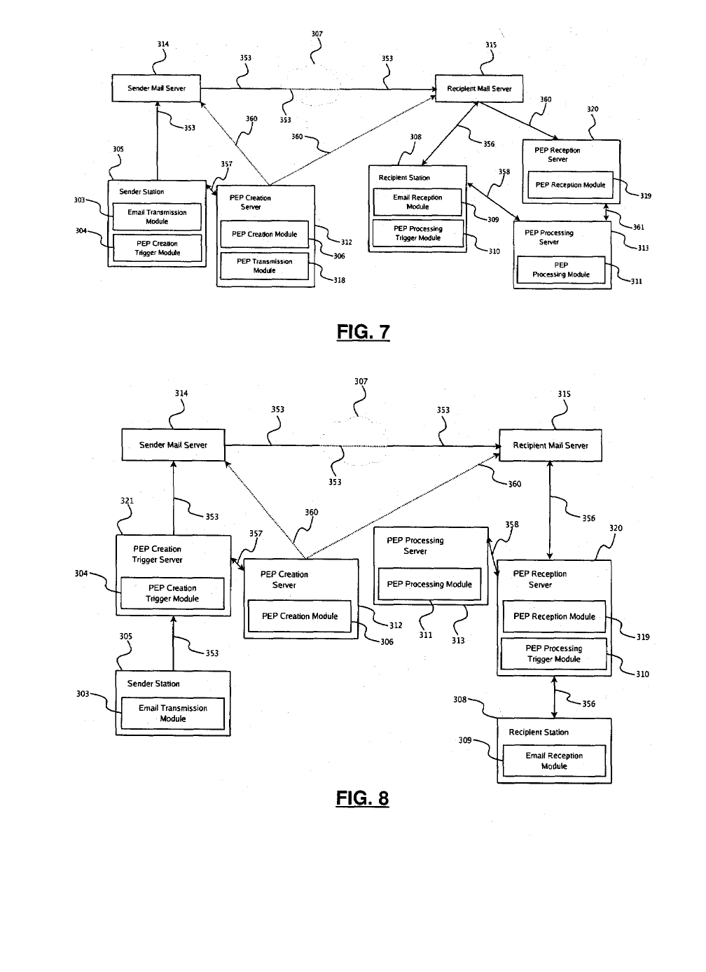

FIGS. 5 to 8 illustrate other possible embodiments of email encryption system according to the present disclosure. In these embodiments there is a payload-encryption-packet transmission module 318 and a payload-encryption-packet reception module 319. In the embodiments illustrated in FIGS. 1 to 4, the payload-encryption-packet transmission module's 318 functionality was fully integrated in either the payload-encryption-packet creation trigger module 304, the payload-encryption-packet creation module 306 or the email transmission module 303, and the payload-encryption-packet reception module's 319 functionality was fully integrated in either the payload-encryption-packet processing trigger module 310 or the email reception module 309. Typically, though not necessarily, embodiments having an explicit payload-encryption-packet transmission module 318 or an explicit payload-encryption-packet reception module 319 have separate paths for the payload-encryption-packet and the encrypted email. This approach, however, further introduces the requirement for providing means for matching payload-encryption-packets to encrypted emails. This can be implemented as a signed serial number, for example.

In the embodiment illustrated in FIG. 5, for example, the payload-encryption-packet is sent directly to the recipient, or recipients, by the payload-encryption-packet creation server 312 either through the sender mail server 314 or the recipient mail server 315 (arrow 360). In this case, the payload-encryption-packet reception module 319 is integrated in the payload-encryption-packet processing trigger module 310 for transmitting the request for processing the payload-encryption-packet when said payload-encryption-packet is received by the payload-encryption-packet reception module 319. This may be a useful configuration if there were a requirement for withholding the payload-encryption-packet at the payload-encryption-packet creation server 312 pending the completion of a transaction, say, for example, the payment for the content in the encrypted email. In the embodiment illustrated in FIG. 6, the payload-encryption-packet is again sent by the payload-encryption-packet creation module 306, but here the recipient mail server 315 transmits the payload-encryption-packet to the payload-encryption-packet processing server 313 instead of it being received by the recipient station 308. This may be a useful configuration for organizations wishing to have tight control over incoming emails in payload-encrypted format. The embodiment illustrated in FIG. 7 introduces a payload-encryption-packet reception server 320 which deals only with storing incoming payload-encryption-packets and communicates with the payload-encryption-packet processing server 313 for synchronizing for the processing of payload-encryption-packets 361. In both embodiments illustrated in FIGS. 6 and 7, communication between the recipient station 308 and the payload-encryption-packet processing server 313 (arrow 358) requires that the payload-encryption-packet processing trigger module 310 provide the payload-encryption-packet processing module 311 with information for it to locate the payload-encryption-packet matching a given encrypted email processed by the payload-encryption-packet processing trigger module 310, which may be the signed serial number mentioned earlier. In other words, this would require the payload-encryption-packet creation module 306 to attribute a unique serial number to each encrypted email and payload-encryption-packet pair so that they could be paired again it sent separately.

In the embodiment illustrated in FIG. 8, the sender station 305 and recipient station 308 remain unchanged with the introduction of the payload-encryption-packet creation trigger module 304 and the payload-encryption-packet processing trigger module 310. Instead, the path of the email as it is sent from the sender station 305 to the sender mail server 314 is made to include a payload-encryption-packet creation trigger server 321 in which the payload-encryption-packet creation trigger module 304 is integrated, and the path of the email as it is transferred from the recipient mail server 315 to the recipient station 308 is made to include a payload-encryption-packet reception server 320 in which the payload-encryption-packet reception module 319 and the payload-encryption-packet processing trigger module 310 are integrated. In this configuration, the payload-encryption-packet creation trigger server 321 substitutes the email sent by the sender station 305 with an email in payload-encryption format and the payload-encryption-packet creation server 312 automatically processes the email in payload-encryption format received from the recipient mail server 315 and substitutes it with the original email and sends it to the recipient station 308 instead of the email in payload-encryption format. This configuration may be of interest in organizations having close ties in which both organization agree to automatically encrypt and decrypt all emails to and from the other organization.

### Third Set of Embodiments

In the embodiment illustrated in FIG. 9, the payload-encryption-packet creation server 312 sends the email directly to the recipient 353 in response to a request for creating a payload-encryption-packet. This configuration may be of interest if the organization using the payload-encryption-packet creation server 312 would wish to reduce its network bandwidth usage and avoid having the email in payload-encryption format returned to the sender station 305 prior to being sent to the sender mail server 314.

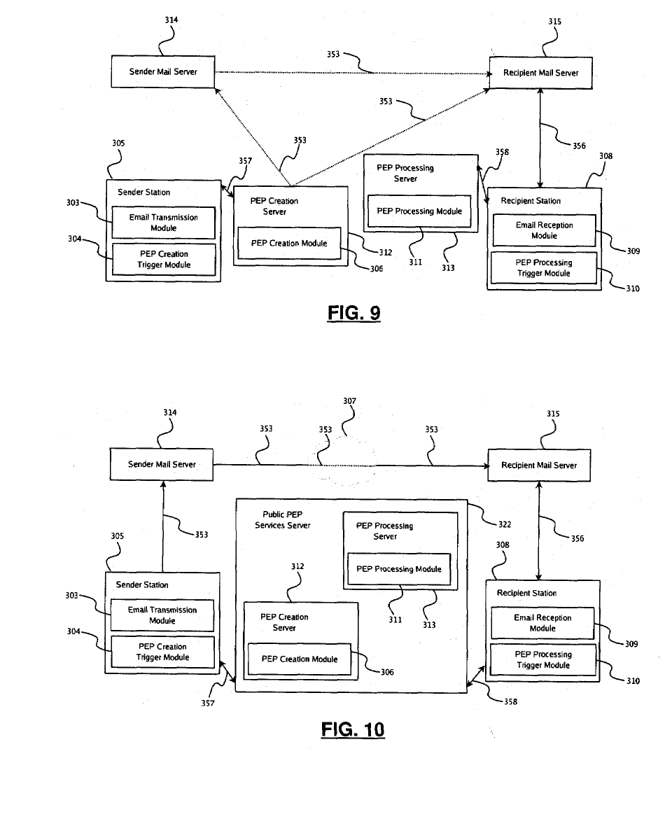

FIG. 10 illustrates an embodiment of the present disclosure where the payload-encryption-packet creation server 312 and the payload-encryption-packet processing server 313 are made to appear as a single network service, the public payload-encryption-packet services server 322. This is the configuration of the system as seen by a non-member recipient when interacting with the payload-encryption-packet processing server 313 to decrypt an email or when interacting with a payload-encryption-packet creation module 306 for encrypting a reply to the sender. This configuration may also be of interest if the email encryption system according to the present disclosure were to be made available via an online subscription to individual users.

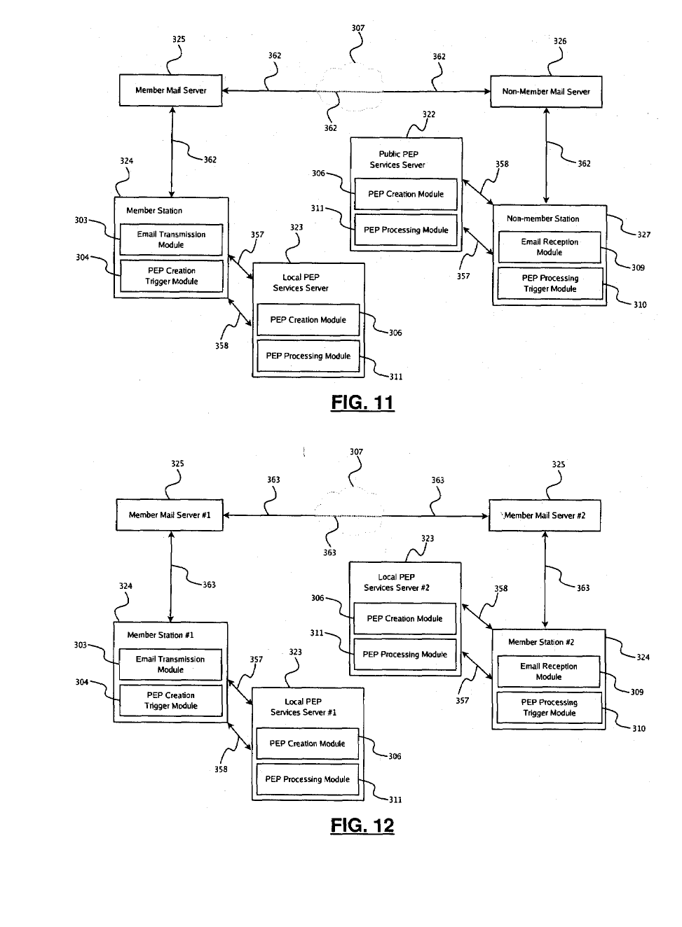

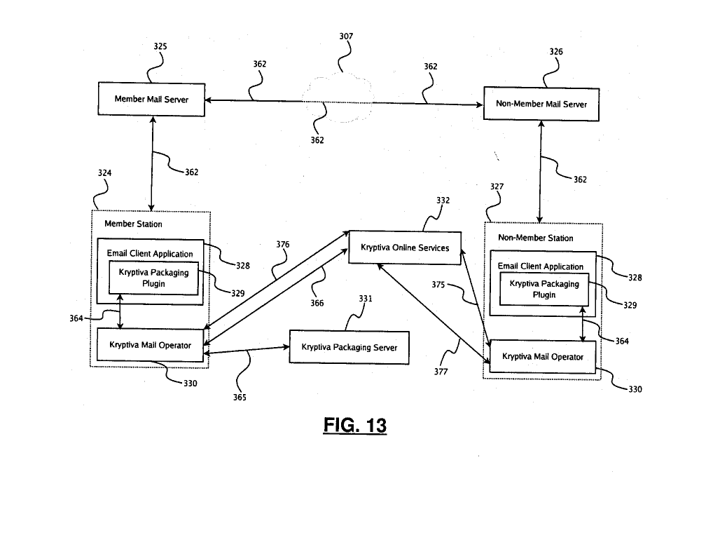

FIG. 11 illustrates an embodiment of the present disclosure where a member uses a local payload-encryption-packet services server 323 and a non-member uses a public payload-encryption-packet services server 322 to securely interact with each other. FIG. 12 illustrates an embodiment of the present disclosure where a first member uses a first local payload-encryption-packet services server 323 and second member uses a second local payload-encryption-packet services server 323 to securely interact with each other.

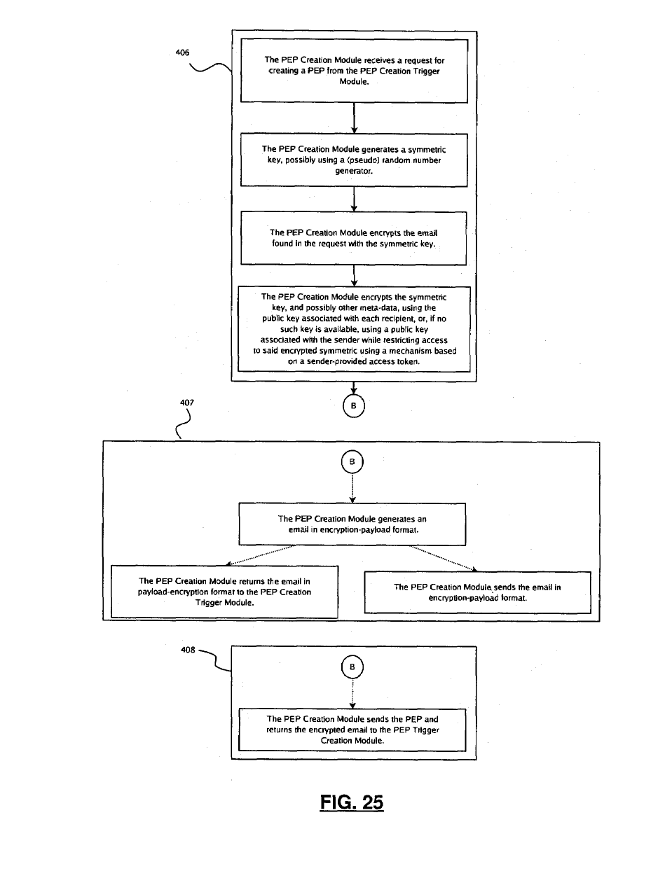

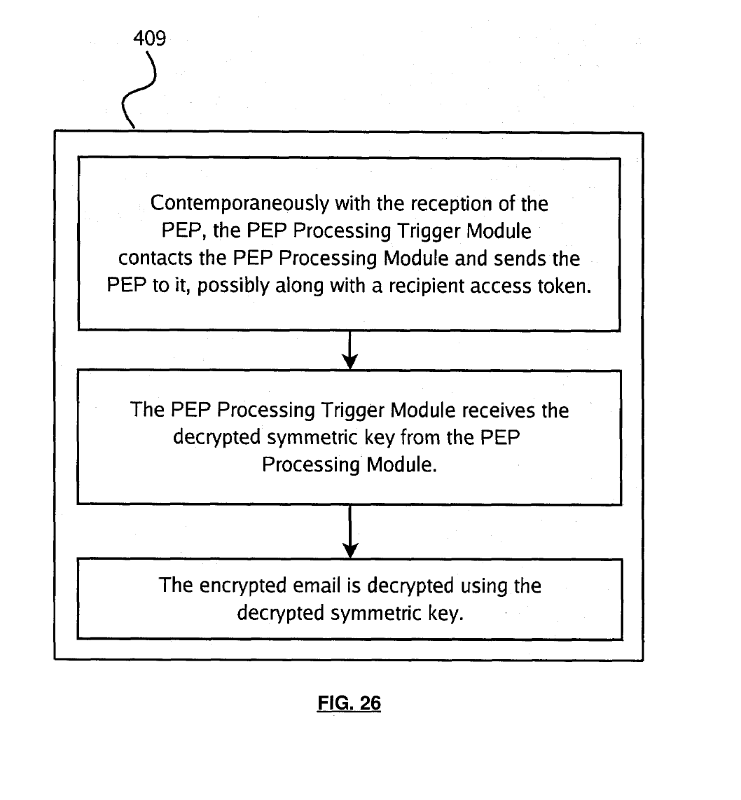

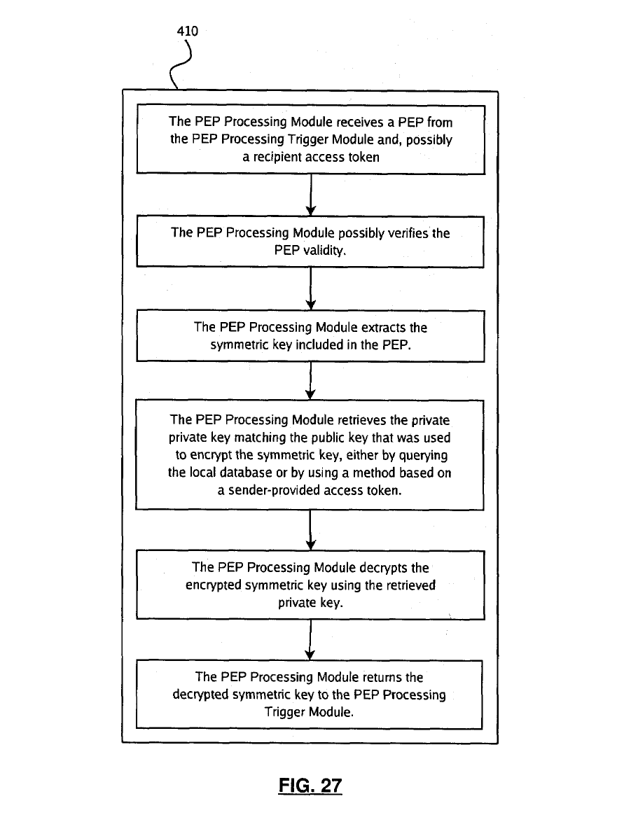

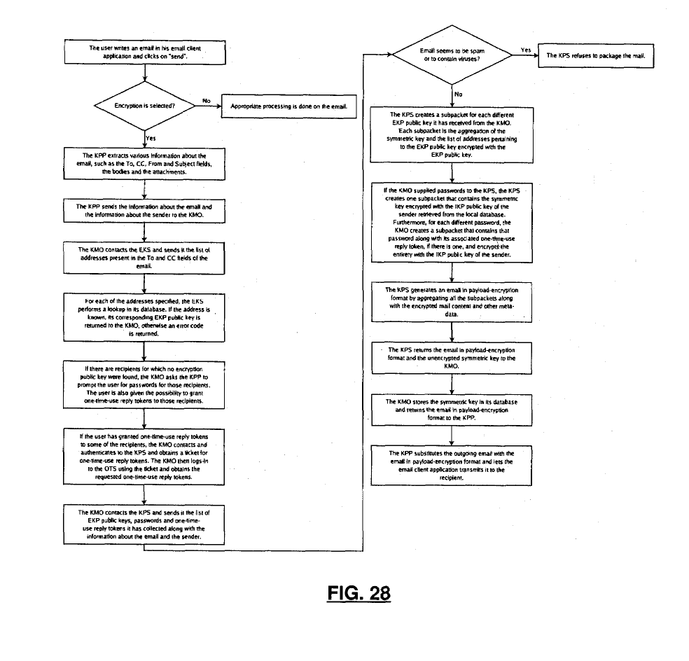

FIGS. 24 to 27 summarize the email encryption method according to the present disclosure. In FIG. 24, the payload-encryption-packet creation trigger module 304 starts by contacting the payload-encryption-packet creation module 306 (steps in 401). The subsequent operation depends the actual system configuration with the payload-encryption-packet creation module 306 either returning the email in payload-encryption format to the payload-encryption-packet creation trigger module 304 (steps in 402), or returning the encrypted email and the payload-encryption-packet for the payload-encryption-packet creation trigger module 304 to create the email in payload-encryption format (steps in 403), or the payload-encryption-packet creation module 306 sending the payload-encryption-packet separately from the encrypted email (steps in 404 and in 405). In FIG. 25, the payload-encryption-packet creation module 306 starts by receiving a request for creating a payload-encryption-packet from the payload-encryption-packet creation trigger module 304 (steps in 406). It then either creates an email in payload encryption format for sending to the recipient (steps in 407) or provides the necessary parts for the payload-encryption-packet creation trigger module 304 to create the email in payload-encryption-format (steps in 408). FIG. 26 illustrates the operation of the payload-encryption-packet processing trigger module 310 (steps in 409) and FIG. 27 illustrates the operation of the payload-encryption-packet processing module 311 (steps in 410).

### Fourth Set of Embodiments

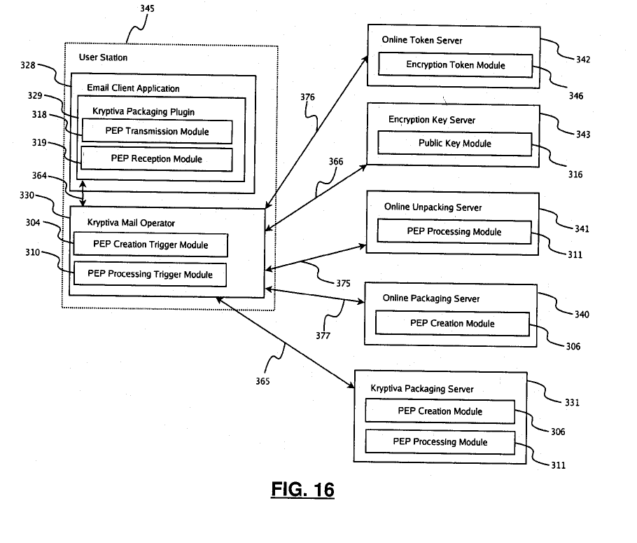

FIG. 13 to 23 illustrate the present disclosure as embodied by the line of products and services marketed by Kryptiva Inc. For the purposes of the present disclosure, Kryptiva Inc. can be typically considered as a TTP with regards to those using its services and components. As such, access to any of the Kryptiva™ components typically involves entering in an agreement with Kryptiva Inc. or obtaining software from it, such as through its website (http://www.kryptiva.com). As illustrated in FIG. 16, the above-described elements can be viewed as built into the Kryptiva™ components in the following fashion:
the payload-encryption-packet creation trigger module 304 and payload-encryption-packet processing trigger module 310 being integrated in the Kryptiva Mail Operator 330 (KMO),
the payload-encryption-packet transmission module 318 and payload-encryption-packet reception module 319 being integrated in the Kryptiva Packaging Plugin 329 (KPP),
a payload-encryption-packet creation module 306 and a payload-encryption-packet processing module 311 being integrated in the Kryptiva Packaging Server 331 (KPS),
the encryption token module 346 being integrated in the Online Token Server 342 (OTS), which itself is part of the Kryptiva Online Services 332 (KOS),
the public key module 316 being integrated in the Encryption Key Server 343 (EKS), which itself is part of the Kryptiva Online Services 332,
a payload-encryption-packet processing module 311 being integrated in the Online Unpacking Server 341 (OTS), which itself is part of the Kryptiva Online Services 332, and
a payload-encryption-packet creation module 306 being integrated in the Online Packaging Server 340 (OPS), which itself is part of the Kryptiva Online Services 332.

FIG. 15 illustrates the integration of these components as part of a typical computer network. The Kryptiva Packaging Plugin 329 and Kryptiva Mail Operator 330 are typically freely available from the Kryptiva Inc. website, the Kryptiva Packaging Server 331 is typically available for organizations on a subscription basis from Kryptiva Inc., and the Kryptiva Online Services 332 is made accessible through the Internet.

As can be seen in FIG. 16, the sender station 305 and recipient station 308 operation of the present disclosure as implemented by the Kryptiva™ components is separated in two pieces, the Kryptiva Mail Operator 330 and the Kryptiva Packaging Plugin 329. There are many advantages to this configuration from a software development and maintenance perspective, but there is little difference from a functionality point of view should the client-side operation been implemented in a monolithic software component. Basically, the Kryptiva Packaging Plugin 329 is very specific to the email client application 328 (otherwise known as MUA or Mail-User Agent) and the Kryptiva Mail Operator 330 is a generic portable application. In other words, while there may be many Kryptiva Packaging Plugin 329 instances, one for each different email client application 328, there is meant to be only one Kryptiva Mail Operator 330 software package supporting all Kryptiva Packaging Plugin 329 instances. Support is implemented in the Kryptiva Packaging Plugin 329 and Kryptiva Mail Operator 330 for dealing with both sender requests for creating emails in payload-encrypted format and recipient requests for processing such emails.

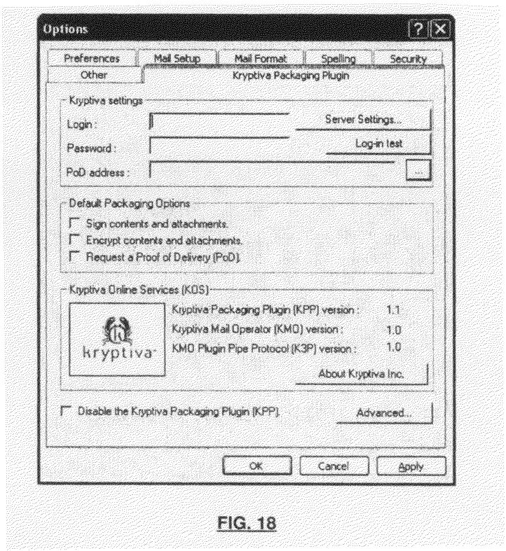

Typically, the Kryptiva Packaging Plugin 329 is implemented such that it hooks to the email client application's 328 “send” and “receive” functionality. The Kryptiva Packaging Plugin 329 for Microsoft® Outlook, for example, interfaces with Outlook using COM/ATL in order to be notified of specific user actions, such as when the “send” button is pressed or when new emails appear in folder or when an email is “opened” by way of double-clicking. The Kryptiva Packaging Plugins 329 for Mozilla Thunderbird™ and other email client applications 328 operate in a similar fashion to the Kryptiva Packaging Plugin 329 for Outlook. The Kryptiva Packaging Plugin 329 allows the user to configure the parameters for interacting with the Kryptiva Packaging Server 331 and the Kryptiva Online Services 332 as illustrated in FIGS. 18 and 19. At startup, the Kryptiva Packaging Plugin 329 launches a Kryptiva Mail Operator 330 instance, establishes a pipe or socket link to it in order to exchange data with it using the K3P 364 and provides it some of the basic information entered by the user in the Kryptiva Packaging Plugin 329 configuration menus for use by Kryptiva Mail Operator 330 in carrying out commands provided to it by the Kryptiva Packaging Plugin 329.

The Kryptiva Packaging Server 331 is implemented based on a customized Linux distribution and runs a daemon for dealing with requests for creating payload-encryption-packets. It contains two key pairs, the “encryption key pair” (EKP) and the “identity key pair” (IKP), as they are known in Kryptiva™ terminology. With regards to the EKP, the private key is located on the Kryptiva Packaging Server 331 only and the corresponding public key is published by the Kryptiva Online Services 332 run by Kryptiva Inc. for allowing senders to send email to users being authorized to use the Kryptiva Packaging Server 331 according to the email encryption system and method of the present disclosure. With regards to the IKP, both the public and the private key are available to the Kryptiva Packaging Server 331 and the Kryptiva Online Services 332. The IKP is typically used for implementing the system and method described in PCT International Publication Number WO 2005/078993. Since this key pair is already shared between the Kryptiva Online Services 332 and the Kryptiva Packaging Server 331 and in order to reduce complexity by avoiding further introducing an additional key pair, the IKP is reused in the context of the present disclosure for allowing users of the Kryptiva Packaging Server 331 to send encrypted email to recipients that do not have access to a local Kryptiva Packaging Server 331. Of course, an additional separate key pair could also be used instead of reusing the existing IKP for other purposes. The EKP is based on 2048-bit RSA keys and the IKP is based on 1024-bit RSA keys.

The Kryptiva Online Services 332 components, such as the Online Unpacking Server 341, Encryption Key Server 343, Online Token Server 342 and Online Packaging Server 340, are also based on customized Linux distribution, such as the KSP. They typically have access to several database and are hosted in a secure location by Kryptiva Inc. for servicing global requests. It would be possible to have a network of independent and/or redundant servers for providing the services of any single component of the Kryptiva Online Services 332.

The Kryptiva Mail Operator 330 is implemented as a portable Unix® application linked with both the Libgcrypt and OpenSSL libraries. It is built natively on Unix® systems, such as Linux®, and is compiled using the MinGW environment in Windows®. The Kryptiva Mail Operator 330 is also linked with the SQLite library for storing information regarding emails it processes locally on the user station 345. Such information includes the symmetric key returned by the Kryptiva Packaging Server 331 at send time in order to allow a sender to read the emails in payload-encryption format that he himself sent, and the symmetric key returned by the Kryptiva Packaging Server 331 at reception time following a successful request for processing a payload-encryption-packet.

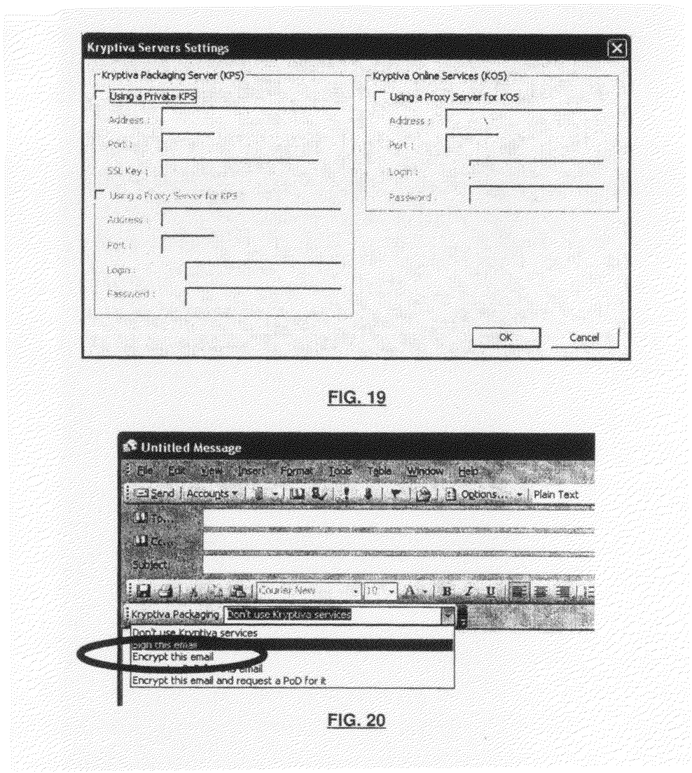

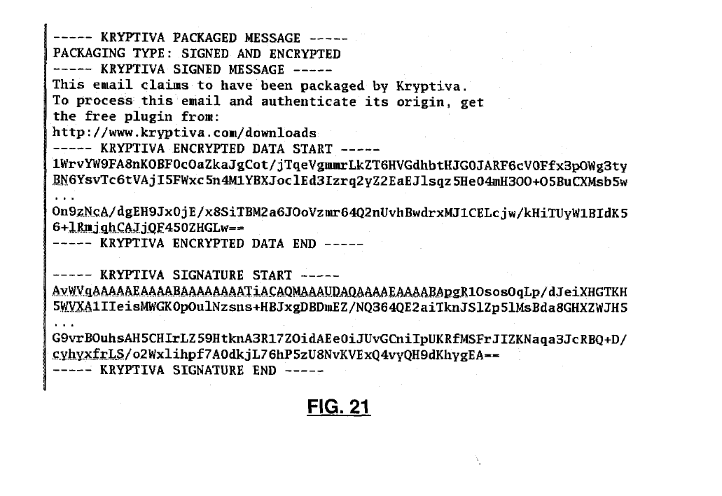

For offering the encryption functionality to the user, the Kryptiva Packaging Plugin 329 displays an additional toolbar to the user's existing email composition window allowing the user to select a “Kryptiva Packaging” option, as illustrated in FIG. 20. The user can write his email as he would normally, and press “send” whenever ready.

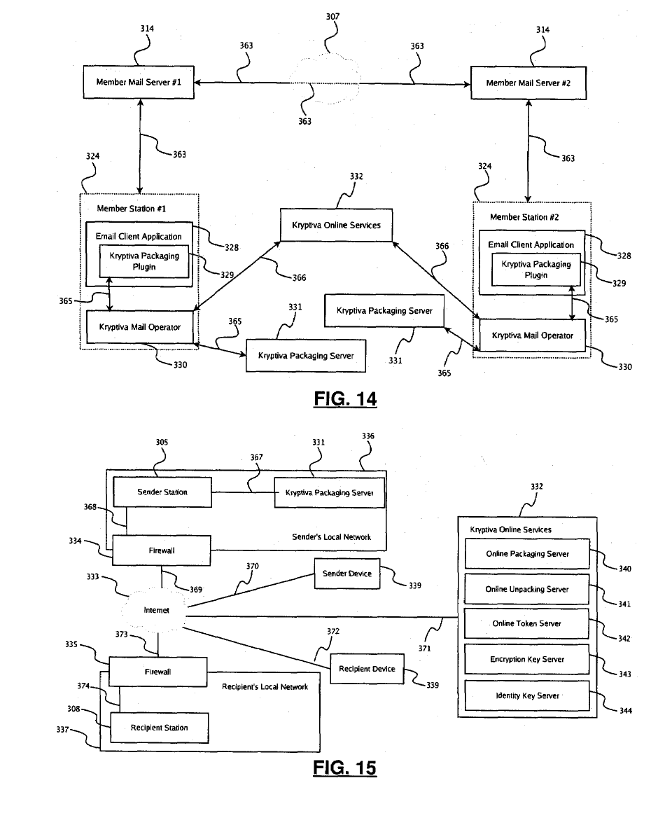

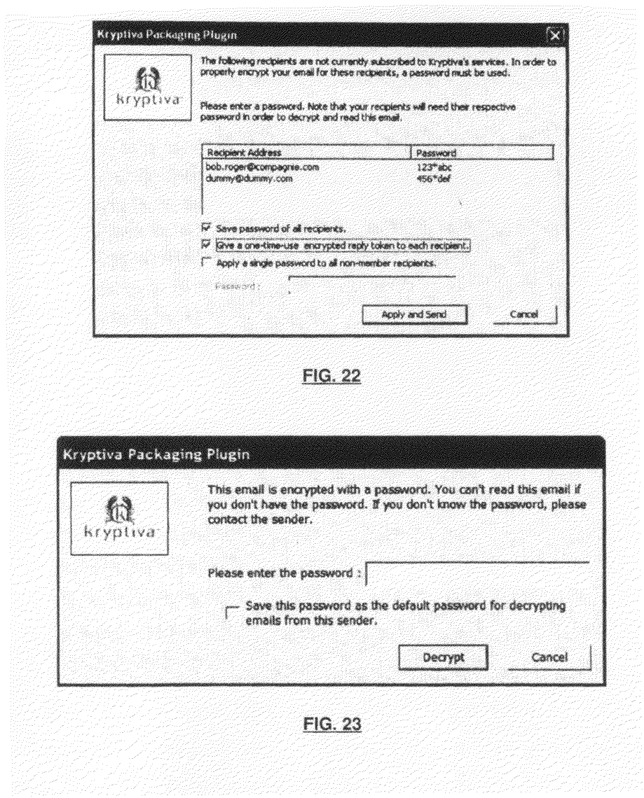

Referring to FIGS. 13 and 14, when the “send” button is pressed, the Kryptiva Packaging Plugin 329 intervenes and determines what needs to be done if a “Kryptiva Packaging” other than “Don't use Kryptiva services” is selected. If the user has selected a request for encryption, the Kryptiva Packaging Plugin 329 proceeds to extract information regarding the outgoing email, such as the To, CC, Subject, and Body, using the interfaces provided by the Outlook API to plugins. Once retrieved, the information is provided to the Kryptiva Mail Operator 330 364 along with instructions for creating an email in payload-encryption format. The Kryptiva Mail Operator 330 first parses the recipient list to identify each recipient's email address. It then contacts the Encryption Key Server 343 and attempts to fetch a public key for each recipient email address 366. The Encryption Key Server 343 has means to find public keys as a function of hashed or partially hashed email addresses and sends the Kryptiva Mail Operator 330 the public keys it finds and a failure message for those it can't find. To ensure that there is no man-in-the-middle attack between the Kryptiva Mail Operator 330 and the Encryption Key Server 343, either the communication between the two can be secured using SSL or the keys provided by the Encryption Key Server 343 can be signed in a fashion that allows said keys to be validated using a copy of a public key available to, or hardcoded in either the Kryptiva Mail Operator 330, the Kryptiva Packaging Server 331 or both. If there were any recipients for which a public key was not found (also known as “non-member” recipients in contrasts to recipients for which a public key was returned by the Encryption Key Server 343 known as “member” recipients), the Kryptiva Mail Operator 330 informs the Kryptiva Packaging Plugin 329 that it must prompt the user to enter a password for those recipients. The Kryptiva Packaging Plugin's 329 dialog box for this is illustrated in FIG. 22.

Having received public keys for some recipients and passwords for other recipients, the Kryptiva Mail Operator 330 then contacts the Kryptiva Packaging Server 331 using SSL, logs in using the information entered by the user in the Kryptiva Packaging Plugin 329 configuration menus, which was provided to the Kryptiva Mail Operator 330 at startup by the Kryptiva Packaging Plugin 329, and forwards the Kryptiva Packaging Plugin's 329 request, along with the public keys found, the passwords obtained and the complete list of recipient email addresses, to the Kryptiva Packaging Server 331 using the KNP 365. Having accepted the Kryptiva Mail Operator's 330 connection and authenticated the sender, the Kryptiva Packaging Server 331 then proceeds to first check whether the email appears to be spam or appears to contain any virus. If so, then the Kryptiva Packaging Server 331 will refuse to create a payload-encryption-packet and will inform the Kryptiva Mail Operator 330 of this which, in turn, will notify the Kryptiva Packaging Plugin 329 and the latter will display a pop-up to the user indicating that a problem has occurred. If there is no problem with the email, the Kryptiva Packaging Server 331 proceeds to create an email in payload-encryption format using the original email provided by the Kryptiva Mail Operator 330.

To that end, the Kryptiva Packaging Server 331 relies on Libgcrypt, an open-source cryptographic library, to conduct the cryptographic operations required for creating an email in payload-encryption format. First, the Kryptiva Packaging Server 331 generates a 128-bit AES symmetric key using Linux's pseudo-random number generator (/dev/urandom) which is used to encrypt the email body. It then creates a payload-encryption-packet by aggregating a number of sub-packets. Each such sub-packet contains information allowing a recipient or a group of recipients to retrieve a decrypted copy of the symmetric key by interacting either with its own Kryptiva Packaging Server 331, if the recipient or group of recipients has itself access to a local Kryptiva Packaging Server 331 as illustrated FIG. 14, or the Kryptiva Online Services 332, it the recipient or group of recipients does not have access to a local Kryptiva Packaging Server 331 as illustrated FIG. 13.

Both in the case of member and non-member recipients, a payload-encryption-packet sub-packet containing the following is generated for each recipient or group of recipients for which a given public key is used for encrypting the symmetric key:
<mid> <type> <len> <enc-symkey>
   wherein:
<mid> is a number uniquely identifying the owner of the key pair to which belongs the public key used for encrypting <enc-symkey>, typically this is a Member ID (MID) as attributed to a Kryptiva Packaging Server 331 by Kryptiva Inc.,
<type> is the key pair to which the public key used for encrypting <enc-symkey> is part of: either EKP it the recipient or recipients are members, or IKP if the recipient or recipients are non-members,
<len> is the size of the <enc-symkey>,
<enc-symkey> is encrypted using the public key, and
<enc-symkey>=<len> <clear-symkey> <recipient-list>, wherein:
   <len> is the size of the aggregate,
   <clear-symkey>=<mid> <key>, wherein <mid> is as explained above and <key> is the actual symmetric key used to encrypt the email, and
   <recipient-list>=<len> <buffer>, wherein <len> is the length of the recipient list and <buffer> contains the plain-text list of comma-separated recipient email addresses.

There may be many such sub-packets, one for each recipient or group of recipients for which a given public key is used, including one such sub-packet containing a symmetric key encrypted using the IKP public key it there were non-member recipients.

In the case of a recipient or group of recipients for which no public key was provided, there is further another type of payload-encryption-packet sub-packet used containing the following:
<len> <encrypted-passwd>
   wherein:
<encrypted-passwd> is encrypted using the public key part of the IKP of the sender's Kryptiva Packaging Server 331, and
<encrypted-passwd>=<with-otut> or <without-otut>, wherein:
   <with-otut>=1<passwd hash> <otut>, wherein <passwd hash> is a cryptographic hash of the sender-provided password and <otut> is an opaque object identifying the one-time-use reply token provided by the encryption token module 346, and
   <without-otut>=0<passwd hash>, wherein <passwd hash> is as described above.
      There may be many such sub-packets, one for each different password provided. Notice that there is no information for identifying the recipient. The reason is that, since the recipient or group of recipients is not known to Kryptiva Inc. (i.e. there is no key published for him/them by the Encryption Key Server 343), the only reliable mechanism for controlling his/their access to the decrypted symmetric key is his/their knowledge of a valid password. In other words, so long as a recipient has a valid password, he will be able to read the email, regardless of whether or not he was part of the sender's list of intended recipients.

Once appropriate sub-packets are generated for each recipient type, they are aggregated together along with other meta-data regarding the email, including the MID corresponding to the KSP, and the entirety is signed, thereby generating a Kryptiva Signature Packet (KSP). The encrypted email and the KSP are combined to form an email in payload-encryption format which is returned back to the Kryptiva Mail Operator 330. The Kryptiva Packaging Server 331 also returns the unencrypted symmetric key to the Kryptiva Mail Operator 330 so that the sender may be able to read the emails in payload-encryption format that he himself sent.

Other algorithms and key sizes than the ones previously mentioned could of course be used without departing from the teaching of the present disclosure. For example, elliptic curve cryptography or ElGamal could possibly be used. Similarly, other methods for generating symmetric keys could be used. For example, the Kryptiva Packaging Server 331 could use the Quantis product from idQuantique which relies on quantum effects for generating pure random numbers.

The Kryptiva Mail Operator 330 then stores the unencrypted symmetric key in the SQLite database and returns the email in payload-encryption format to the Kryptiva Packaging Plugin 329 which, in turn, substitutes the outgoing email with the email in payload-encryption format and lets Outlook transmit it as it would have transmitted the original email if the Kryptiva Packaging Plugin 329 were not present. FIG. 21 illustrates an email in payload-encryption format as generated by the Kryptiva Packaging Server 331.

At reception, or when the user opens an email, depending on the configuration, the Kryptiva Packaging Plugin 329, if it is installed, detects email in payload-encryption format and sends it to the Kryptiva Mail Operator 330 for preprocessing. First, Kryptiva Mail Operator 330 does a number of verifications on the email it receives from the Kryptiva Packaging Plugin 329, including checking the signature of the KSP and the email's integrity. It also checks for the email's packaging and reports all the information it finds back to the Kryptiva Packaging Plugin 329.

If the recipient is a non-member and the sender had provided a password to the Kryptiva Packaging Server 331 at the time the email in payload-encryption format was created, the Kryptiva Packaging Plugin 329 will prompt the recipient for the password as it is known to him as illustrated in FIG. 23. If the user doesn't know the password the email cannot be decrypted and it is left to the user in its encrypted form. Once a password is entered, it is provided to Kryptiva Mail Operator 330 along with the email in payload-encrypted format for decryption.

If the recipient is a member and has properly configured his Kryptiva Packaging Plugin 329 for interacting with a local Kryptiva Packaging Server 331, then no password is required and the email in payload-encrypted format is sent as-is to the Kryptiva Mail Operator 330 for decryption. If the recipient is a non-member, the Kryptiva Mail Operator 330 then contacts the Online Unpacking Server 341 of the Kryptiva Online Services 332 (arrow 375), provides it with the KSP and the recipient-provided password with a request for processing the payload-encryption-packet. The Online Unpacking Server 341 first verifies the integrity of the KSP, then retrieves all <encrypted-passwd> sub-packets, decrypts each one using the private key of the IKP matching the MID found in the KSP and attempts to find a match for the hash of the recipient-provided password. If no such match is found, the Online Unpacking Server 341 informs the Kryptiva Mail Operator 330 that the email could not be decrypted with the password provided, the Kryptiva Mail Operator 330 in turn informs the Kryptiva Packaging Plugin 329 that the password is invalid and, finally, the Kryptiva Packaging Plugin 329 displays a pop-up to that effect to the recipient. If a match is found, the Online Unpacking Server 341 retrieves from the KSP the payload-encryption-packet sub-packet containing the encrypted symmetric key that had been encrypted using the IKP public key, decrypts the <enc-symkey> found in that sub-packet using the IKP private key and returns the <key> therein found to the recipient's Kryptiva Mail Operator 330 (arrow 375).

If the recipient is a member, the Kryptiva Mail Operator 330 interacts with the local Kryptiva Packaging Server 331 (arrow 365) to decrypt the email. Having received appropriate login information from the Kryptiva Online Services 332, the Kryptiva Packaging Server 331 first verifies the integrity of the KSP, then retrieves the sub-packet containing the encrypted symmetric key that had been encrypted using its EKP public key, decrypts the <enc-symkey> found in that sub-packet using the EKP public key, verifies that the email address of the user account with which Kryptiva Mail Operator 330 logged in to the Kryptiva Packaging Server 331 is listed as part of the <recipient-list>, and, if so, returns the <key> therein found to the recipient's Kryptiva Mail Operator 330 (arrow 375).

Having received a symmetric key from either the Online Unpacking Server 341 or the Kryptiva Packaging Server 331, the Kryptiva Mail Operator 330 then stores this key in association with a unique identifier for the email to which it is designated into a local database for future use, decrypts the email using Libgrycpt and returns the decrypted email to the Kryptiva Packaging Plugin 329. The Kryptiva Packaging Plugin 329 then displays the email for the user using the API provided to plugins by the email client application.

As illustrated in FIG. 22, a member sender can provide a one-time-use reply token for non-members to use for replying in encrypted fashion to the sender. If this option is selected, it is passed by the Kryptiva Packaging Plugin 329 to the Kryptiva Mail Operator 330 as part of its instructions for producing an email in payload-encrypted format. Having received this option, the Kryptiva Mail Operator 330 contacts the local Kryptiva Packaging Server 331 to which the sender has access and request a ticket for a one-time-user reply token. The Kryptiva Packaging Server 331 produces such a ticket partly by signing a timestamp using the IKP private key. Having received a ticket from the Kryptiva Packaging Server 331, the Kryptiva Mail Operator 330 then contacts the Online Token Server 342 (arrow 376), provides it with the ticket and obtains an actual one-time-use reply token. The token is then provided to the Kryptiva Packaging Server 331 by the Kryptiva Mail Operator 330 for inclusion as part of the payload-encryption-packet sub-packets for non-member recipients. For its part, when the Online Token Server 342 receives a ticket, it first validates that its signature is genuine using the IKP public key, creates an unique entry in a database for the one-time-user reply token and returns a unique identifier for this entry as the one-time-use reply token to the Kryptiva Mail Operator 330.

When a non-member recipient receives an email in payload-encrypted format including a one-time-use reply token, he cannot use this token until he has successfully decrypted the symmetric key by contacting the Online Unpacking Server 341 and providing it with the appropriate password. As part of decrypting an encrypted symmetric key for a non-member recipient, the Online Unpacking Server 341 retrieves the one-time-user reply token found in the <encrypted-passwd>. If such a token is present, it is returned to the Kryptiva Mail Operator 330 along with the decrypted symmetric key for use in a future reply by the recipient. When replying, the non-member's Kryptiva Mail Operator 330 uses the one-time-use reply token to log into the Online Packaging Server 340 (arrow 375) and create an email in payload-encrypted format for sending to the original member sender that had granted the token to the recipient. The operation of the Online Packaging Server 340 for a non-member recipient replying to a member having granted him a one-time-use token is similar to that a member's Kryptiva Mail Operator 330 interacting with a local Kryptiva Packaging Server 331 for creating an email in payload-encrypted format as described above, except that the non-member is capable of securely replying to the original sender only. For its part, the Online Packaging Server 340 receiving a one-time-use reply token would typically look up the entry for that token created in the database by the Online Token Server 342 and “consume” the token.

Token consumption means that the Online Token Server 342 either deletes this entry or decrements a counter associated with that token until the counter reaches zero, at which point it is deleted from the database. Typically, the Kryptiva Mail Operator 330 specifies the number of recipients it wishes to give a one-time-use reply token as part of its request to the Kryptiva Packaging Server 331 for a ticket for a one-time-user reply token. This quantity can then be propagated as part of the ticket until it reaches the Online Token Server 342 which could include it as part of the information associated with the token entry in the token database. Each responding non-member would then “consume” part of the token until all recipients have responded or the count attached to the token is reached. Some recipients may attempt to abuse from this mechanism by consuming the tokens of other recipients, but this would easily be identified by the member sender having granted the tokens since he would have received more than one secure reply from a given recipient. Of course there are human considerations to such abuse which the participating individuals may need to sort out.

For better integration with existing network infrastructure, an organization's Kryptiva Packaging Server 331 can be connected to a local LDAP server 349 (connector 381) for authenticating users. In that case, the username and password entered in the Kryptiva Packaging Plugin 329 configuration window, as illustrated in FIG. 18, are sent to the LDAP server 349 by the Kryptiva Packaging Server 331 when the Kryptiva Mail Operator 330 connected to the Kryptiva Packaging Plugin 329 attempts to log in to either create emails in payload-encrypted format or process emails in payload-encrypted format. This avoids system administrators from having to maintain a separate user database on the Kryptiva Packaging Server 331, though this is something that can be done if the system administrators preferred.

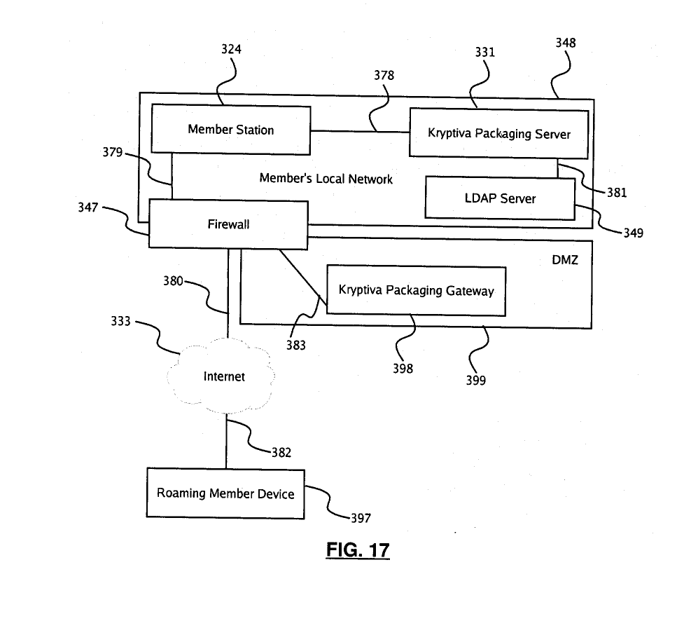

Since the Kryptiva Packaging Server 331 is typically hidden behind a corporate firewall, as illustrated in FIGS. 15 and 17, roaming users or users outside the firewall cannot typically access the services of the Kryptiva Packaging Server 331. To circumvent this issue without requiring that outside users have VPN access to the corporate network, a Kryptiva Packaging Gateway 398 can be used within an organization's DMZ 399 for relaying outside requests to the internal Kryptiva Packaging Server 331 as illustrated in FIG. 17. This setup simplifies auditing and remote access control since the Kryptiva Packaging Gateway 398 does not itself have any direct access to either the IKP or the EKP stored by the Kryptiva Packaging Server 331.

FIGS. 28 and 29 summarize the email encryption method of the present disclosure as implemented by the Kryptiva™ components. FIG. 28 illustrates the creation and sending of an email in payload-encryption format while FIG. 29 illustrates the reception and processing of an email in payload-encryption format.

While this disclosure uses a combination of private and public keys and a symmetric key to obtain an email encryption system and method, other combinations of cryptographic algorithms could be used to achieve the same functionality. Namely that the payload-encrypUon-packet may be packaged remotely from a sender's station yet locally on a sender's network, preferably, but not necessarily, without requiring the sender to contact a server outside the firewall, while still requiring the recipient to contact a server to process the payload-encryption-packet and therefore obtain access to information enabling him to read an email he's received. Also, it is worth noting that while the present disclosure uses the term “email”, it will be evident to those skilled in the art that the present disclosure may be applicable to other forms of communication which resemble email such as, for example, instant messaging and GSM SMS messages.

It will be understood that numerous modifications and changes in form and detail may be made to the embodiments of the presently disclosed system and method for providing end-to-end electronic mail encryption. It is contemplated that numerous other configuration of the system and method may be used, and the modules of the system and method may be selected from numerous modules other than those specifically disclosed. Therefore, the above description should not be construed as limiting the disclosed system and method, but merely as exemplification of the various embodiments thereof. Those skilled in the art will envisioned numerous modifications within the scope of the present disclosure as defined by the claims appended hereto. In short, it is the intent of the Applicant that the scope of the patent issuing herefrom will be limited only by the scope of the appended claims. Having thus complied with the details and particularity required by the patent laws, what is claimed and desired protected is set forth in the appended claims.

What is claimed is:

1. An email encryption system, the system comprising:
an email transmission module configured for sending an email;
a payload-encryption-packet creation module operating remotely from the email transmission module, the payload-encryption-packet creation module being configured for producing a payload-encryption-packet in response to a request for creating a payload-encryption-packet, wherein the payload-encryption-packet is produced as a function of an encryption key;
a payload-encryption-packet creation trigger module connectable to the payload-encryption-packet creation module, the payload-encryption-packet creation trigger module being configured for, contemporaneously with the sending of the email:
generating the request for creating the payload-encryption-packet,
causing the generation of an encrypted email, wherein the encrypted email is produced as a function of the email and the encryption key, and
causing the substitution of the email with the encrypted email;
a payload-encryption-packet processing module configured for returning the encryption key in response to a request for processing the payload-encryption-packet; and
a payload-encryption-packet processing trigger module connectable to the payload-encryption-packet processing module, the payload-encryption-packet processing trigger module being configured for triggering the request for processing the payload-encryption-packet contemporaneously with the reception of the payload-encryption-packet and receiving the encryption key, thereby enabling the decryption of the encrypted email.

2. A system for email encryption, the system comprising:
an email transmission module configured for sending an email;
a payload-encryption-packet creation module operating remotely from the email transmission module, the payload-encryption-packet creation module being configured for producing a payload-encryption-packet in response to a request for creating the payload-encryption-packet, wherein the payload-encryption-packet is produced as a function of data identifying the recipient;
a payload-encryption-packet creation trigger module connectable to the payload-encryption-packet creation module, the payload-encryption-packet creation trigger module being configured for generating the request for creating the payload-encryption-packet contemporaneously with the sending of the email and configured for causing the email to be substituted with an encrypted email, wherein the encrypted email is produced as a function of the email and cryptographic information found in the payload-encryption-packet;
a payload-encryption-packet processing module configured for returning cryptographic information necessary for decrypting the encrypted email in response to a request for processing the payload-encryption-packet;
an email reception module configured for receiving the email; and
a payload-encryption-packet processing trigger module connectable to the payload-encryption-packet processing module, the payload-encryption-packet processing trigger module being configured for triggering the request for processing the payload-encryption-packet contemporaneously with the reception of the payload-encryption-packet, whereby the cryptographic information returned by the payload-encryption-packet processing module is used to decrypt the encrypted email received by the email reception module.

3. A system of claim 2, further comprising:
a payload-encryption-packet transmission module configured for causing the sending of the payload-encryption-packet; and
a payload-encryption-packet reception module configured for receiving the payload-encryption-packet.

4. A system according to claim 2, wherein the payload-encryption-packet processing module enabling requests for processing payload-encryption-packets to enable access to the payload-encryption-packet creation module.

5. A system according to claim 2, wherein the payload-encryption-packet creation module is separate from the payload-encryption-packet processing module.

6. A system according to claim 2, wherein the payload-encryption-packet processing module requires requests for processing payload-encryption-packets to be authenticated.

7. A system according to claim 6, further comprising a random key generation module connectable to the payload-encryption-packet creation module, the random key generation module being configured for generating a symmetric key.

8. A system according to claim 7, further comprising a symmetric key encryption module connectable to the payload-encryption-packet creation module, the symmetric key encryption module being configured for producing an encrypted symmetric key as a function of a public key and the symmetric key, wherein the encrypted symmetric key is made to be a component of the payload-encryption-packet.

9. A system according to claim 8, further comprising an email encryption module connectable to the payload-encryption-packet creation module, the email encryption module being configured for producing the encrypted email as a function of the symmetric key.

10. A system according to claim 9, further comprising a payload-encryption-packet formatting module configured for producing an email in payload-encryption format by combining the encrypted email with the payload-encryption-packet.

11. A system according to claim 10, wherein the payload-encryption-packet formatting module is connectable to payload-encryption-packet creation module.

12. A system according to claim 10, wherein the payload-encryption-packet formatting module is connectable to the payload-encryption-packet creation trigger module.

13. A system according to claim 10, further comprising a payload-encryption-packet transmission module configured for substituting the email with the email in payload-encryption format, wherein said substitution is effected contemporaneously with the transmission of the email by the email transmission module.

14. A system according to claim 13, wherein the payload-encryption-packet transmission module is connectable to the payload-encryption-packet creation trigger module.

15. A system according to claim 13, wherein the payload-encryption-packet transmission module is connectable to the payload-encryption-packet creation module.

16. A system according to claim 13, wherein the email received by the email reception module is the email in payload-encryption format.

17. A system according to claim 16, wherein the payload-encryption-packet processing module is further configured for receiving the payload-encryption-packet part of the email in payload-encryption format.

18. A system according to claim 17, wherein the payload-encryption-packet processing module is further configured for decrypting the symmetric key found in the payload-encryption-packet using a private key.

19. A system according to claim 18, wherein the payload-encryption-packet processing module is further configured to return the decrypted symmetric key to the payload-encryption-packet processing trigger module.

20. A system according to claim 19, wherein the payload-encryption-packet processing trigger module is further configured for decrypting the encrypted email found as part of the email in payload-encryption format using the decrypted symmetric key.

21. A system according to claim 2, wherein the email transmission module is a sender's email client application.

22. A system according to claim 21, wherein the payload-encryption-packet creation trigger module is connected to the sender's email client application by way of a plugin.

23. A system according to claim 22, wherein the email reception module is a recipient's email client application.

24. A system according to claim 23, wherein the payload-encryption-packet processing trigger module is connectable to the recipient's email client application by way of a plugin.

25. A system according to claim 24, wherein the payload-encryption-packet creation module is integrated in a payload-encryption-packet creation server.

26. A system according to claim 25, wherein the payload-encryption-packet processing module is integrated in a payload-encryption-packet processing server.

27. A system according to claim 26, wherein the email transmission module and the payload-encryption-packet creation trigger module are integrated in a sender unit.

28. A system according to claim 27, wherein the email reception module and the payload-encryption-packet processing trigger module are integrated in a recipient unit.

29. A system according to claim 28, wherein the sender unit is a sender station.

30. A system according to claim 29, wherein the recipient unit is a recipient station.

31. A method for email encryption, the method comprising:
a) generating a request for producing a payload-encryption-packet contemporaneously with the sending of an email, wherein the email is sent by an email transmission module;
b) producing a payload-encryption-packet remotely from the email transmission module in response to the request for producing a payload-encryption-packet;
c) producing an encrypted email as a function of the email and cryptographic information contained in the payload-encryption-packet;
d) substituting the email with the encrypted email;
e) generating a request for processing the payload-encryption-packet contemporaneously with the reception of the payload-encryption-packet; and
extracting the cryptographic information found in the payload-encryption-packet for use in decrypting the encrypted email received by the email reception module.

32. A method for email encryption, the method comprising:
a) generating a request for producing a payload-encryption-packet contemporaneously with the sending of an email, wherein the email is sent by an email transmission module;
b) generating a symmetric key remotely from the email transmission module in response to the request for producing a payload-encryption-packet, wherein the content of the payload-encryption-packet can only be accessed by authorized recipients;
c) encrypting the email using the symmetric key, thereby obtaining an encrypted email;
d) encrypting the symmetric key using a public key, thereby obtaining an encrypted symmetric key;
e) substituting the email with an email in payload-encryption format, wherein the email in payload-encryption format is produced as a function of the encrypted email and the encrypted symmetric key;
f) generating a request for processing the payload-encryption-packet contemporaneously with the reception of the email in payload-encryption format by an email reception module;
g) authenticating the recipient on whose behalf the request for processing the payload-encryption-packet is generated;
h) decrypting the encrypted symmetric key found in the email in payload-encryption format using a private key, thereby obtaining a decrypted symmetric key; and
i) decrypting the encrypted email found in the email in payload-encryption format using the decrypted symmetric key.
